(19) United States
(12) Patent Application Publication
(10) Pub. No.: US 2025/0335961 A1
(43) Pub. Date: Oct. 30, 2025

(54) DATASET GENERATION PIPELINE USING LARGE LANGUAGE MODELS AND VISION LANGUAGE MODELS

(71) Applicant: Target Brands, Inc., Minneapolis, MN (US)

(72) Inventors: MIN WANG, Sunnyvale, CA (US); ATA MAHJOUBFAR, Sunnyvale, CA (US)

(73) Assignee: Target Brands, Inc., Minneapolis, MN (US)

(21) Appl. No.: 19/007,282

(22) Filed: Dec. 31, 2024

Related U.S. Application Data
(60) Provisional application No. 63/640,707, filed on Apr. 30, 2024.

(51) Int. Cl. G06Q 30/0601; G06N 20/00

(52) U.S. Cl. CPC G06Q 30/0627; G06N 20/00

(57) ABSTRACT

In general, a model development platform that includes a dataset generation system is disclosed. The dataset generation system may generate a dataset, which may be useable to train or validate performance of a multi-modal machine learning model. To generate a sample of the dataset, the dataset generation system may use an initial query to search for a reference item and target item. The dataset generation system may use one or more of a large language model or vision language model to generate a follow-up query. In some embodiments, the multi-modal machine learning model may validate the dataset, which may then be used to train the multi-modal machine learning model, which may then be used to generate a subsequent dataset creating, in some embodiments, a cyclical process for improving the machine learning model.

### CROSS-REFERENCE TO RELATED APPLICATIONS

The present application claims priority from U.S. Provisional Patent Application No. 63/640,707, entitled “Dataset Generation Pipeline Using Large Language Models and Vision Language Models”, filed on Apr. 30, 2024, the disclosure of which is hereby incorporated by reference in its entirety.

### BACKGROUND

In machine learning, a sufficient quantity of quality training data is important for developing a model. Data scarcity can limit a model's ability to learn meaningful patterns, leading to poor performance on real-world tasks. Insufficient data not only restricts the model's capacity to generalize across different scenarios but can also hinder its ability to capture nuances in the target domain. This is particularly evident in applications that require domain-specific understanding, where a lack of diverse examples that are pertinent to the relevant domain can result in suboptimal performance and decreased reliability. Consequently, acquiring a sufficient quantity of high-quality data may be an important step in developing effective machine learning models. Relatedly, acquiring a sufficient quantity of diverse, high-quality data for validating model performance once it has been trained may likewise be an important step in developing effective machine learning models.

Attaining high-quality training data may present significant challenges, particularly when it comes to labeled data specific to a given domain. Labeling data may require resource-intensive domain expertise, resulting in insufficiently large training datasets. This challenge is exacerbated for multi-modal models that integrate different types of data, such as images and text, since each modality may require at least some distinct labeling criteria and methods. Moreover, this challenge is exacerbated when labels are complex, such as a free-form text queries or various facets of item data. Moreover, ensuring consistency and accuracy of labels across diverse data types, while also efficiently generating labels, adds another layer of complexity. As an example, a domain-specific chatbot may use a machine learning that requires a robust training dataset related to the domain in which the chatbot is implemented. Without such data, the chatbot may provide irrelevant or incorrect results, or may be otherwise limited.

### SUMMARY

In general, a model development platform that includes a dataset generation system is disclosed. The dataset generation system may generate a dataset, which may be useable to train or validate performance of a multi-modal machine learning model. To generate a sample of the dataset, the dataset generation system may use an initial query to search for a reference item and target item. The dataset generation system may use one or more of a large language model (LLM) or vision language model (VLM) to generate a follow-up query. In some embodiments, the multi-modal machine learning model may validate the dataset, which may then be used to train the multi-modal machine learning model, which may then be used to generate a subsequent dataset, thereby creating, in some embodiments, a cyclical process for improving performance the machine learning model.

In a first example, a dataset generation system is disclosed. The dataset generation system includes a computing system including one or more computing devices having a processor and a memory, the memory storing computer-implemented instructions executable on the processor to cause the computing system to generate a dataset having a plurality of samples, each sample of the plurality of samples including a respective initial query, a respective reference item, a respective follow-up query, and a respective target item, wherein generating the dataset comprises: obtaining a plurality of initial queries; for each initial query of the plurality of initial queries: determining a reference item; determining a target item, wherein the target item includes a modification relative to the reference item; and generating a follow-up query, wherein generating the follow-up query comprises: providing the initial query and a first prompt to a large language model (LLM) to determine an attribute type associated with the initial query; providing the attribute type, reference item data, target item data, and a second prompt to a model to determine a reference item attribute value for the attribute type and a target item attribute value for the attribute type; and providing a third prompt to the LLM to generate the follow-up query based on a difference between the reference item attribute value and the target item attribute value.

In a second example, a model development platform is disclosed. The platform comprises a dataset generation system configured to generate a training dataset comprising a plurality of samples, wherein generating the training dataset comprises: accessing a plurality of initial queries; and for each initial query of the plurality of initial queries: determining a reference item corresponding to the initial query; determining a target item using data associated with the reference item; and generating a follow-up query using one or more of a large language model (LLM) or a vision language model (VLM) to identify a difference between the reference item and the target item; a dataset evaluation system configured to validate the training dataset using a multi-modal model to generate a validated training dataset, the validated training dataset comprising a subset of samples of the plurality of samples of the training dataset, wherein validating the training dataset comprises: for each sample of the plurality of samples: inputting an initial query of the sample, a reference item of the sample, and a follow-up query of the sample into the multi-modal model; using the multi-modal model to infer a target item; and comparing the inferred target item with the target item of the sample; a model training system configured to train the multi-modal model using the validated training dataset.

In a third example, a method for generating a training dataset for a multi-modal machine learning model is disclosed. The method comprises by one or more processors executing computer-readable instructions: obtaining a plurality of initial queries; for each initial query of the plurality of initial queries: determining a reference item; determining a target item, wherein the target item includes a modification relative to the reference item; and generating a follow-up query, wherein generating the follow-up query comprises: providing the initial query and a first prompt to a large language model (LLM) to determine an attribute type associated with the initial query; providing the attribute type, reference item data, target item data, and a second prompt to a model to determine a reference item attribute value for the attribute type and a target item attribute value for the attribute type; and providing a third prompt to the LLM to generate the follow-up query based on a difference between the reference item attribute value and the target item attribute value; validating the training dataset using the multi-modal machine learning model; and training the multi-modal machine learning model using the validated training dataset.

### BRIEF DESCRIPTION OF THE DRAWINGS

FIG. 1 illustrates a schematic diagram of an example model development platform.

FIG. 2 is a flowchart of an example method according to aspects of the present disclosure.

FIG. 3 is a flowchart of an example method for generating a dataset.

FIG. 4 is a flowchart of an example method for generating a follow-up query.

FIG. 5 is a flowchart of an example method for determining differences from text data.

FIG. 6 is a flowchart of an example method for determining differences from image data.

FIG. 7 is a flowchart of an example method for evaluating a dataset.

FIG. 8 is a flowchart of an example method for generating target item data.

FIG. 9 is a flowchart of an example method for generating target item embeddings.

FIG. 10 illustrates a schematic diagram of example operations of a recommender system.

FIG. 11A illustrates aspects of an example recommendation session.

FIG. 11B illustrates aspects of an example recommendation session.

FIG. 11C illustrates aspects of an example recommendation session.

FIG. 12 illustrates an example network environment in which a search tool may be implemented.

FIG. 13 illustrates an example computing system with which aspects of the present disclosure may be implemented.

### DETAILED DESCRIPTION

As briefly described above, aspects of the present disclosure relate to a model development platform. The platform may include a dataset generation system and a multi-modal machine learning model. In some examples, the dataset generation system generates a synthetic domain-specific dataset that may be used as training data to improve performance of the multi-modal machine learning model.

In example aspects, components of the model development platform may perform operations related to generating a dataset, evaluating a dataset, training a multi-modal model, evaluating the multi-model modal, and deploying a multi-modal model. To generate a dataset, a dataset generation system may generate samples that may include queries and item data. The item data may include text and image data. In some embodiments, a given sample includes an initial query, a reference item, a follow-up query, and a target item.

In example aspects, the dataset generation system determines initial queries from historical user queries. For each initial query, the dataset generation system may determine a corresponding reference item, such as by searching for item embeddings that are similar to embeddings for the initial query. The dataset generation system may then determine a target item, which may share features with reference item but may have one or more modifications. In some embodiments, the target item is selected from among a set of nearest neighbors to the reference item. The target item may also correspond, at least in part, with the initial query.

In example aspects, the dataset generation system generates a follow-up query for the sample. In some embodiments, the follow-up query corresponds to a user query that refers to the reference item and that indicates one or more modifications to the reference item to attain the target item. In some embodiments, the dataset generation system repeatedly communicates with one or more LLMs or one or more VLMs to generate the follow-up query. As an example, the dataset generation system may prompt a model to identify significant attribute types associated with the initial query, generate questions pertaining to the attribute types, determine respective attribute values for the reference item and target item, evaluate differences in attribute values, and generate a synthetic natural language query that is based at least in part on differences of significant attribute types between the reference and target item. In some embodiments, outputs from an LLM and VLM may be combined as part of generating a follow-up query, and different LLMs or VLMs may be used for different operations when generating the follow-up query.

In example aspects, a multi-modal machine learning model may validate samples of the generated dataset. For instance, for a given sample, the model may infer a target item based on an initial query, reference item, and follow-up item. If the model correctly infers the target item, then that sample may be validated. In some embodiments, a dataset with validated samples is output by the dataset generation system and may be used to further train the multi-modal model, such that a model development cycle is created in which the multi-modal model is part of generating a dataset, then that dataset is used to improve the multi-modal model, which is then used to generate a subsequent dataset, and so on, thereby improving the performance of the multi-modal model with each iteration.

Depending on the embodiment, the architecture of the multi-modal model may vary. In some embodiments, the multi-modal model is trained to generate target item embeddings, which may be subsequently used in various downstream tasks, such as, for example, as part of a chatbot, which may in turn be part of a recommender or search system. Depending on the embodiment, the multi-modal pipeline may have a different architecture for generating target embeddings and may have different layers or parameters that are trained using data from the dataset generation system. As an example, the multi-modal model may generate target item embeddings based on an aggregation of initial query embeddings, reference item embeddings, and follow-up query embeddings. As another example, target item data may be generated, and the multi-modal model may generate text target item embeddings and image target item embeddings. In some embodiments, the multi-modal model is trained to fuse embeddings from the text and image modalities.

In an example implementation of aspects of the present disclosure, an online retailer may offer a chatbot to which a user may submit a query for an item. That query may result in presentation to the user of a number of items determined by the chatbot. In some examples, the user may submit a follow-up query to refine the set of results presented. This iterative process with the chatbot may occur one or more additional times. Such a chatbot is particularly useful for small-format devices which are not readily able to show image and text description data regarding a large number of potential items of interest concurrently. In that context, the chatbot presents a small number of items, and the user may iteratively modify the features of such items. The queries may be provided as unstructured feedback-that is, although in some instances a user may effectively be able to navigate a set of filters of goods (e.g., Apparel->Men's Apparel->Athletic Apparel->Shorts-> . . . ) to arrive at a reasonably small set of items for review, in other instances, the way in which the user interacts with the chatbot is not directly aligned with those predefined filters. For example, the user may wish to identify shorts with stripes on them, or with other particular attributes that are not reflected in predefined filters. In this context, because of a robust, diverse, and domain-specific training data, the multi-modal machine learning model used by the chatbot may be able to accurately identify items matching such free-form queries and thereby enable the chatbot to ingest such queries. Example aspects of such a chatbot used in the context of a recommender or search system is described in U.S. patent application Ser. No. 18/317,593, entitled “Multi-Modal Machine Learning Model and System”, filed on May 15, 2023, which is incorporated herein by reference in its entirety.

Aspects of the present disclosure provide various technical advantages. Among other advantages, generating datasets according to aspects of the present disclosure addresses issues of data scarcity in machine learning. For example, such a dataset may capture a wide variety of domain-specific scenarios and edge cases that may be practically impossible to generate at scale with conventional technology. As a result, a multi-modal model described herein may be developed that learns complexity and nuances of a domain that may not be gleaned using data that is simply scraped from general sources (e.g., data that is publicly accessible from the internet), that is more resilient to overfitting, and that is better at generalizing, making it capable of performing effectively on unseen data, which may improve performance of a downstream system in which the multi-modal model is implemented.

A domain-specific chatbot is an example of an improved system in which the multi-modal model is implemented. For example, because the accuracy or precision of the multi-modal machine learning model is improved, the chatbot may return more accurate results more quickly across a diverse set of user inputs. Advantageously, the chatbot may be a multi-modal chatbot that is enabled by a multi-modal dataset generated by aspects of the present disclosure. For example, different modalities may have unique characteristics and relationships that can be difficult to capture with a generic dataset. By generating a domain-specific multi-modal dataset, the model development platform may enhance the multi-modal model's ability to align data native to different modalities, thereby improving the multi-modal model's performance, particularly with respect to its ability to understand cross-modality patterns in data. Furthermore, in some embodiments, by training the model on text and image data from a particular item catalog and historical queries that were actually submitted by users to a particular retailer, the chatbot may be specifically tuned to interact with users searching for items in the particular item catalog.

Additionally, with high-quality, tailored datasets, such as the generated datasets described herein, models can converge more quickly during training, reducing the computational resources and time required to achieve optimal performance. This efficiency allows for more rapid iterations in model development and deployment, making it feasible to experiment with different architectures of the multi-modal model, as described, for instance, in connection with different possible architectures of the multi-modal model described herein. Additionally, improved datasets can lead to better memory management, as they help models focus on the most relevant features and reduce redundancy, ultimately leading to lighter models that require less memory to run. Additionally, because item collections may change rapidly, it may be difficult to maintain an accurate training dataset usable to train a model that assists with identification of items within a catalog. Accordingly, a dataset generation pipeline is described herein which assists with generation of a robust training dataset across a wide variety of item categories, thereby enabling broad use of such a multi-modal approach across many categories of items, including those which may have limited available data without the use of synthetic data creation.

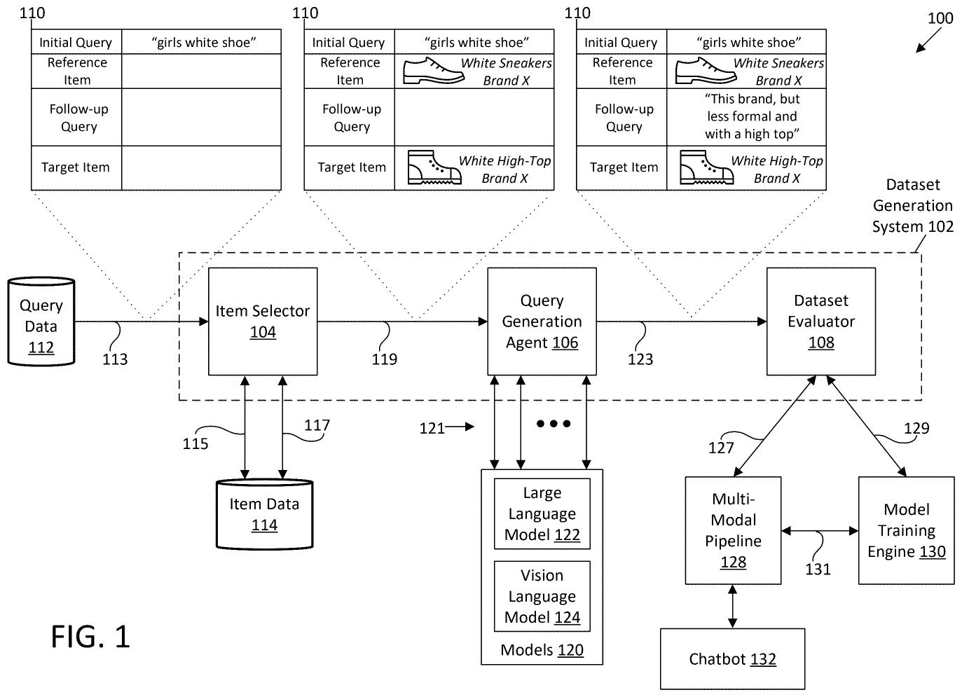

FIG. 1 illustrates an example model development platform 100 in which aspects of the present disclosure may be implemented. In some embodiments, components of the model development platform 100 may be part of a computer information system of an entity that uses or develops machine learning models. Whereas some components of the platform 100 may be owned or developed by the entity, or reside in a network managed by the entity, other components of the platform 100 may be associated with a third party. In some embodiments, the entity is a retailer. In some embodiments, one or more of the components of the model development platform 100 may be implemented in a computer network environment. For example, one or more of the components in the example of FIG. 1 may exchange data over a network. The network may be, for example, a wireless network, a wired network, a virtual network, the internet, or another type of network. Furthermore, the network may be divided into subnetworks, and the subnetworks may be different types of networks. In some embodiments, the model development platform 100 may be implemented in a cloud-based environment, which may include one or more of a multi-cloud or hybrid-cloud environment. The model development platform 100 may include more or fewer components than illustrated in the example of FIG. 1.

In the example shown, the model development platform 100 includes a dataset generation system 102, query data 112, item data 114, models 120, a multi-modal pipeline 128, a model training engine 130, and a chatbot 132. Additionally, FIG. 1 illustrates an example sample 110 of an example dataset that may be generated using components described in connection with FIG. 1 Additionally, FIG. 1 illustrates example operations 113, 115, 117, 119, 121, 123, 127, 129, and 131 that may be performed using one or more components described in connection with FIG. 1. Although operations of FIG. 1 may be described as associated with a particular sample of a dataset, it will be understood that such operations may be used to generate a plurality of samples and a plurality of datasets.

The dataset generation system 102 includes software and hardware for performing one or more operations associated with generating a dataset. The dataset generation system 102 may include one or more components, such as, for example, an item selector 104, a query generation agent 106, and a dataset evaluator 108. The dataset generation system 102 may include more or fewer components than those described in connection with FIG. 1. As examples, the dataset generation system 102 may include a component for managing data, storing data, coordinating operations of other components of the dataset generation system 102, or performing other operations.

A dataset generated by the dataset generation system 102 may include a plurality of samples. The sample 110 is an example of a sample of the dataset. In some embodiments, each sample is a labeled sample of training data or validation data for use in connection with the multi-modal pipeline 128. In some embodiments, each sample includes one or more of the following: an initial query; a reference item; a follow-up query; and a target item. In some embodiments, a sample of the dataset corresponds to a round of conversation with a multi-modal chatbot in which the initial query is received by the chatbot, the reference item is output by the chatbot, the follow-up query is received by the chatbot, and the target item is output by the chatbot. Example aspects of initial queries, reference items, follow-up queries, and target items are described in U.S. patent application Ser. No. 18/317,593.

In some embodiments, the initial query may be data that corresponds to an initial search. In an example, the search may be for an item. In some instances, the initial query is provided by a human user to a web application or mobile application that includes an item search application. In some instances, the initial query is provided by a bot. In some embodiments, the initial query is an alphanumeric string. In some embodiments, the initial query is a transcribed voice input. In some embodiments, the initial query is multi-modal. For example, the initial query may include text and image data corresponding to a searched—for item. In some embodiments, the initial query is represented as embeddings. In some embodiments, the initial query is text or other data that represents a plurality of previous conversation states with a chatbot or with an iterative recommender system. For example, the initial query may represent all previous conversation states, rather than only a single previous query.

The reference item may include data corresponding to an item. The reference item may correspond to the initial query. For example, if the initial query is for “patterned gray outdoor umbrella,” then the reference item may be data of an item that matches the query. The reference item may include text information and image information of the item. Examples of types of data of the reference item that may be part of the sample 110 are described in connection with the item data 114.

The follow-up query may be data that corresponds to a search that is subsequent to the initial query. In some embodiments, the follow-up query refers to the reference item and indicates one or more modifications to the reference item. As such, the follow-up query may include a selection of the reference item or data from the reference item. In some embodiments, the follow-up query specifies a target item that is the same as the initial query but with some attributes that are different from the initial query. The follow-up query may share a format with the initial query. For example, the follow-up query may be an alphanumeric string. In some embodiments, the follow-up query is a transcribed voice input. In some embodiments, the follow-up query is multi-modal. For example, the follow-up query may include text and image data corresponding to a searched—for item. In some embodiments, the follow-up query is represented as embeddings.

The target item may include data corresponding to an item. The target item may correspond to the follow-up query. In some embodiments, the target item is an item that represents the modifications to the reference item indicated by the follow-up query. In some embodiments, the target item may satisfy both the initial query and the follow-up query, unlike the reference item, which may satisfy the first attribute but not the second attribute. The target item may include text information and image information of the item. Examples of types of data of the target item that may be part of the sample 110 are described in connection with the item data 114.

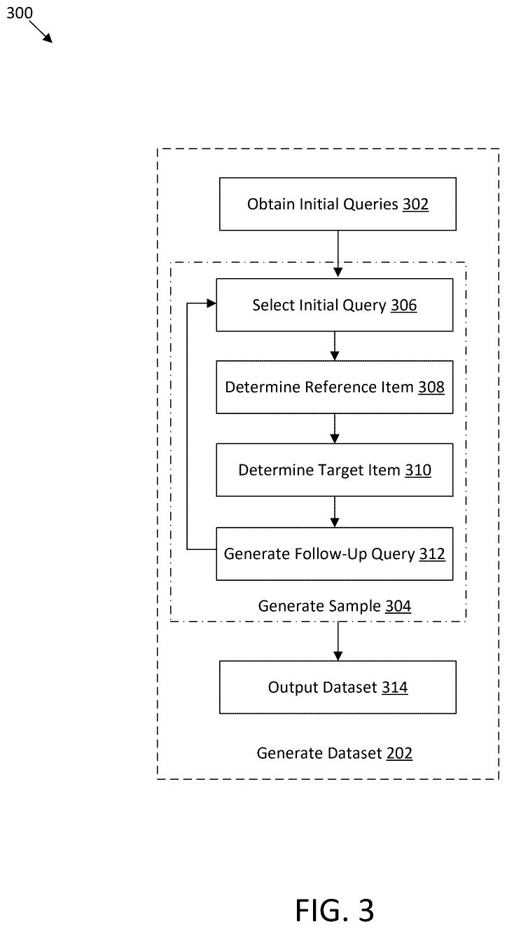

The item selector 104 may, for example, access initial queries and determine reference items and target items for the initial queries. The item selector 104 may include an interface for exchanging data with databases that store query data 112 and item data 114. In some embodiments, the item selector 104 may perform aspects of a method for generating training data, an example of which is further described in connection with FIG. 3. In some embodiments, the item selector 104 performs operations associated with a data preparation phase.

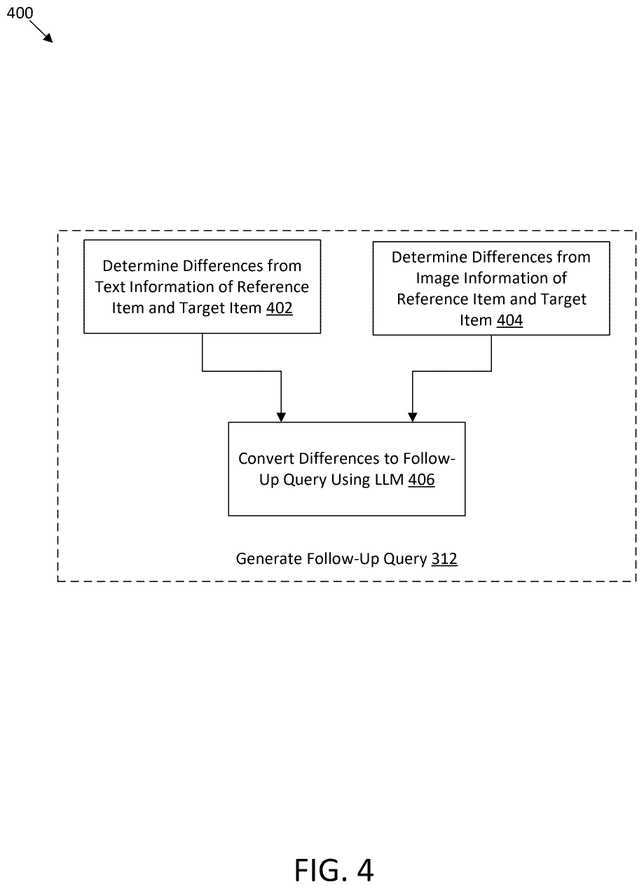

The query generation agent 106 may, for example, determine follow-up queries. In some embodiments, the query generation agent 106 coordinates an iterative sequence of communications with models of the models 120 as part of generating a follow-up query for a sample. Example aspects of generating a follow-up query are further described in connection with FIG. 4-6.

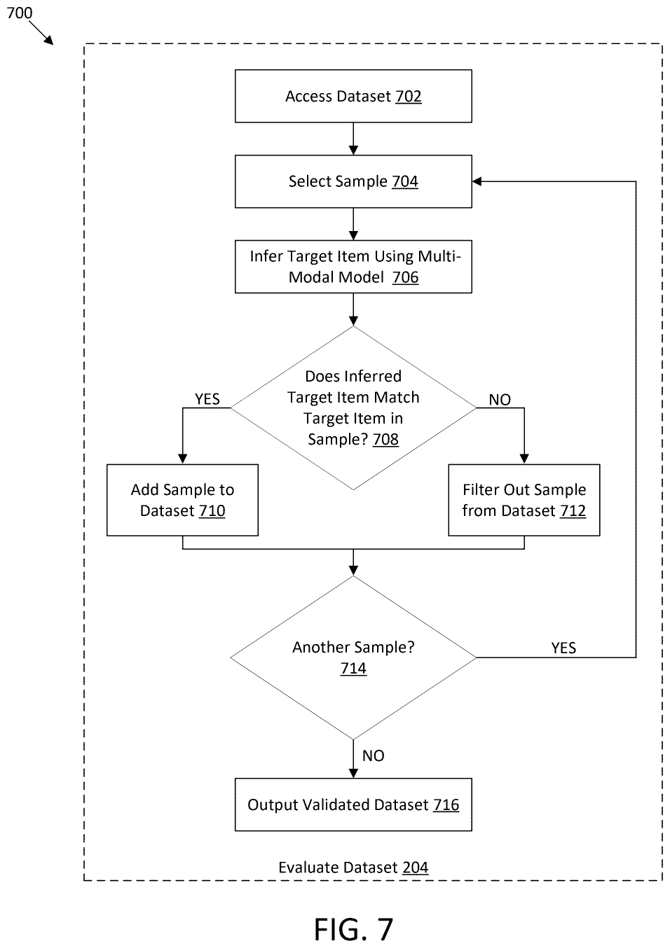

The dataset evaluator 108 may, for example, evaluate samples of a dataset generated by the item selector 104 and the query generation agent 106 to generate a validated dataset. To do so, the dataset evaluator 108 may, in some embodiments, use the multi-modal pipeline 128. Example operations of the dataset evaluator are further described in connection with FIG. 7. Additionally, the dataset evaluator 108 may exchange data with a model training engine 130.

The query data 112 may include a plurality of initial queries. In some embodiments, the query data 112 is stored in a database that includes initial queries. The database may be communicatively coupled with an online retail system. For example, the query data 112 may include historical queries input into a search function of an online retailer. In some embodiments, the query data 112 may include additional data. For example, query data 112 may include not only initial queries but may include subsequent actions or searches pertaining to the digital retail system. Relatedly, the query data 112 may include metrics associated with the historical searches, such as a number of times that a given initial query—or a group of queries similar to the given initial query-were input into the digital retailer system. Additionally, queries in the query data 112 may include data that represents a conversation. For example, multiple queries may belong to a same conversation, which may correspond to a sequence of searches by a given user of an online retailer system.

Additionally, the query data 112 may be associated with item data 114. For example, for a given historical initial query (or a given historical group of queries belonging to a given conversation), there may be one or more associated items of the item data, where these items correspond to items that were actually displayed by a search or recommender system or that were actually purchased by a user associated with the queries. The query data 112 may also include metadata for initial queries, such as a time, device, domain, or user associated with the query. In some embodiments, at least some of the initial queries of the query data 112 may be synthetically generated.

In the example shown, the item selector 104 may access an initial query from the query data 112 (step 113), example details of which are further described in connection with the step 302 of FIG. 3. In the example shown, the initial query is “girls white shoe,” as shown in the example sample 110.

The item data 114 may include data for a plurality of items. In some embodiments, the plurality of items correspond to items of a retailer catalog. For each item, the item data 114 may include text data and image data. The text information may include data that describes the item, such as attribute types and corresponding attribute values for the attribute types. For example, if the item is a pair of shoes, then the item data may have attribute types of “color” and “size”, which may, respectively, have attribute values of “white” and “8”. Additionally, the text information may include, but is not limited to, the following information: title; description; category; reviews; price; identifier (e.g., SKU); location; demand; availability; time; special feature; or other data. The image data may include one or more photos, pixel maps, videos, or other visual data associated with the reference item. Further example aspects of the item data are described in connection with the item data 208 of U.S. patent application Ser. No. 18/317,593.

In the example shown, the item selector 104 may determine a reference item corresponding to the initial query (step 115), example aspects of which are further described in connection with step 306 of FIG. 3. In some embodiments, the item selector 104 may perform an embedding-based search across a plurality of items of a catalog of items in the item data 114. In the example shown, the title of the reference item may be “White Sneakers Brand X.” In the example shown, the item selector 104 may determine a target item corresponding to one or more of the reference item or the initial query (step 117), example aspects of which are further described in connection with step 308 of FIG. 3. In some embodiments, the item selector 104 may select the target item from among nearest neighbors of the reference item. In the example shown, the title of the target item may be “White High-Top Brand X.”

In the example shown, the item selector 104 may provide the initial query, reference item, and target item of the sample 110 to the query generation agent 106 (step 119).

The models 120 may include a plurality of machine learning models. In some embodiments, the models 120 include generative artificial intelligence models. In some embodiments, the models 120 may receive a prompt from the query generation agent 106, process the prompt to generate an output, and return the output to the query generation agent 106. In addition to the prompt, the models 120 may receive additional data from the query generation agent 106, such as data that is referred to by the prompt. Additionally, in some embodiments, one or more of the models 120 may not be trained for a specific domain. In some embodiments, one or more of the models 120 may not be fine-tuned with data that corresponds to a chatbot used in a recommender or search system for a retailer. Instead, in some embodiments, one or more of the models 120 may be pre-trained on a vast amount of general data scraped from the internet. In some embodiments, one or more of the models 120 may be configured to generate a follow-up query, identify item attributes, determine differences between items, identify attributes associated with queries, or perform other operations associated with generating a dataset. In some embodiments, the models 120 are provided by a third party. As shown, the models 120 may include a large language model 122 and a vision language model 124.

The large language model (LLM) 122 may be a model that can receive text data and generate a text response. In some embodiments, the large language model 122 includes a neural network, which may use transformers, that can perform natural language processing tasks. The large language model 122 may be trained on an extensive amount of data, enabling it to learn complex patterns in syntax, semantics, and contextual relationships. In some embodiments, the large language model 122 includes more than a billion trainable parameters. In some embodiments, the large language model 122 is integrated into a chatbot with which the query generation agent 106 may interact. In some embodiments, the large language model 122 comprises multiple large language models. In some embodiments, the models 120 includes a plurality of different LLMs 122. For example, although a first step described herein may refer to the LLM 122, and a second step described herein may also refer to the LLM 122, such steps may, in fact, be performed by different large language models. Additionally, in some embodiments, multiple different LLMs may be used to perform a single task that refers to the LLM 122.

The vision language model (VLM) may be a model that can receive text data and image data and generate one or more of text data or image data as a response. In some embodiments, the VLM 124 shares architectural features with the large language model 122. For example, in some embodiments, the VLM 124 may include a neural network and a transformer architecture and may be trained on an extensive amount of data using deep learning techniques. In some embodiments, the VLM 124 is trained on multi-modal data. For example, the VLM 124 may be trained using image-text pairs. In some embodiments, the VLM 124 is trained to fuse data from the text and image modalities. In some embodiments, the VLM 124 is integrated into a chatbot with which the query generation agent 106 may interact. In some embodiments, the VLM 124 comprises multiple models. In some embodiments, the models 120 includes a plurality of different VLMs 124.

In the example shown, query generation agent 106 may generate a follow-up query (step 121), example aspects of which are described in connection with FIGS. 3-6. In some embodiments, generating the follow-up query includes performing a plurality of subtasks that correspond to interactions with one or more of the LLM 122 or the VLM 124. As an example, the query generation agent 106 may use the models 120 to identify significant differences between the reference item and the target item, and based on such differences, generate a follow-up query. In the example shown, the follow-up query is “This brand, but less formal and with a high top.”

In some instances, it may be advantageous to generate the follow-up query using an iterative sequence of queries with the models 120, as opposed to a single query, which may be challenging for the models 120 to accurately process. For example, the models 120 may fail to accurately capture notable differences between the reference item and target item, fail to properly align attribute values and attribute types, or may mistakenly label identical attribute values from two items as significant differences. However, such errors have been experimentally shown to be reduced by providing the models 120 with more context, such as by using a sequence of smaller tasks to generate a context prior to prompting the models 120 to generate a follow-up query, as described, for example, in connection with FIGS. 4-6.

In the example shown, the query generation agent 106 may provide the initial query, reference item, follow-up query, and target item of the sample 110 to the dataset evaluator 108 (step 123).

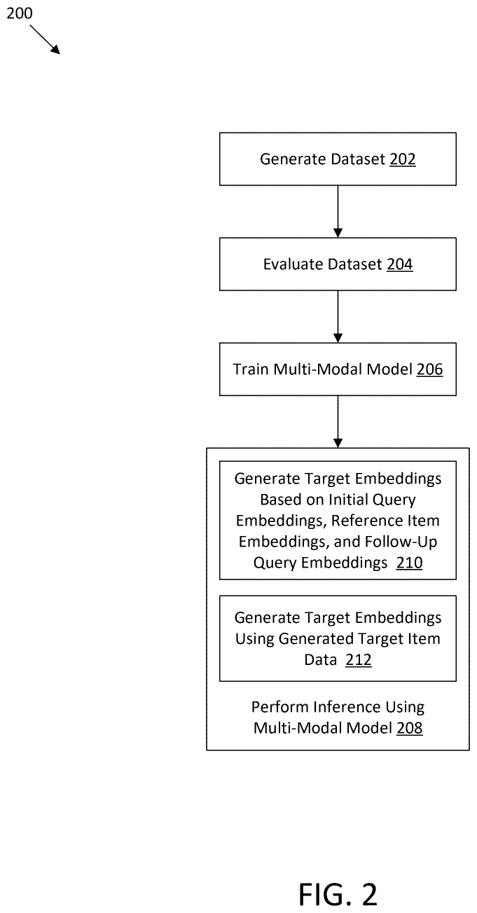

The multi-modal pipeline 128 may be a pipeline that is configured to receive text and image data and generate a multi-modal embedding. In some embodiments, the multi-modal pipeline 128 is, or includes, a multi-modal model. In some embodiments, the multi-modal pipeline includes a machine learning model or includes a combination of machine learning models. In some embodiments, the multi-modal pipeline 128 is integrated into another application. For example, the multi-modal pipeline 128 may be part of a recommender system or search system, which may include a chatbot interface. For instance, the multi-modal pipeline 128, or an application that uses the multi-modal pipeline 128, may receive one or more of text or image data, generate embeddings that represents the one or more of the text or image data, and determine an item that corresponds to the generated embeddings. As an example, the multi-modal pipeline 128 may generate, based at least in part on an initial query, reference item, and follow-up query, target embeddings for a synthesized target item. Depending on the embodiments, the multi-modal pipeline 128 may use a different technique for generating target embeddings, examples of which are further described in connection with FIG. 2. In some embodiments, parameters of a specific model in the multi-modal pipeline 128, or subsets of parameters of the specific model in the multi-modal pipeline 128, may be trained by the model training engine 130. In some embodiments, the multi-modal pipeline 128 is fine-tuned for a particular domain, such as performing an item search in a retail context or performing an item search for a particular retailer or collection of items. Example aspects of the multi-modal pipeline 128, and of applications in which the multi-modal pipeline 128 may be implemented are further described in U.S. patent application Ser. No. 18/317,593.

In the example shown, the dataset evaluator 108 may evaluate the sample 110 (step 127), which may include using the multi-modal pipeline 128. For example, the dataset evaluator 108 may provide the sample 110 to the multi-modal pipeline 128. Based on the initial query, follow-up query, and target item, the multi-modal pipeline 128 may infer a target item, and the dataset evaluator 108 may determine whether the inferred target item matches the target item of the sample 110. If so, the sample may be successfully validated. Example aspects of validating the dataset are described in connection with step 204 of FIG. 2 and in connection with the method described in connection with FIG. 7.

The model training engine 130 may include software and hardware configured to train the multi-modal model in the multi-modal pipeline 128. Example aspects of the model training engine 130 are further described in U.S. patent application Ser. No. 18/317,593.

In the example shown, the dataset evaluator 108 may provide a dataset to the model training engine 130 to train multi-modal model (step 129). In some embodiments, the dataset provided to the model training engine 130 is a validated training set. The validated training dataset may include samples of the training dataset that were successfully validated by the dataset evaluator 108 using the multi-modal pipeline 128.

In the example shown, the model training engine may train the multi-modal model in the multi-modal pipeline 128 using data received from the dataset generation system 102 (step 131), example aspects of which are further described in connection with the operation 206 of FIG. 2.

Advantageously, as shown by the example operations of FIG. 1, the dataset generation system 102, the multi-modal pipeline 128, and the model training engine 130 may perform a series of cyclical operations that iteratively improve performance of the multi-modal pipeline 128 and refine training data generated by the dataset generation system 102. For example, because a training dataset that is generated by the dataset generation system 102 may include data that is validated by the multi-modal pipeline 128, the multi-modal pipeline 128 determines, at least in part, the training data generated by the dataset generation system 102. That training data may then be used to train the multi-modal model in the multi-modal pipeline 128, thereby improving its performance. The trained and improved multi-modal model can then subsequently be used by the dataset generation system 102 to generate a subsequent training dataset, or to refine which samples previously generated by the dataset generation system 102 are validated, thereby generating additional training data. This additional training data can then be used by the model training engine 130 to further train the multi-modal model in the multi-modal pipeline 128, thereby further improving the multi-modal pipeline 128. Such a cyclical process of dataset generation and model training may result in an improved training process as compared to conventional training techniques and conventional techniques of generating synthetic training data. For example, the multi-modal model in the multi-modal pipeline 128 may ultimately have improved accuracy, precision, and recall than it otherwise would if it were not used as part of generating the training dataset. In example testing, accuracy of the multi-modal increased from 59.6% to 70.7% due to the cyclical dataset generation, validation, and training process described herein.

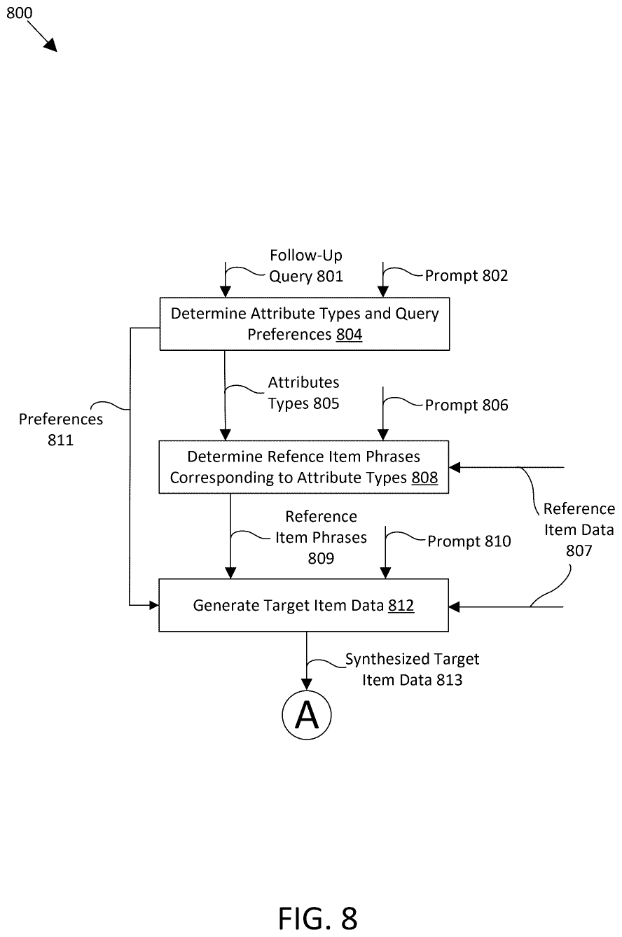

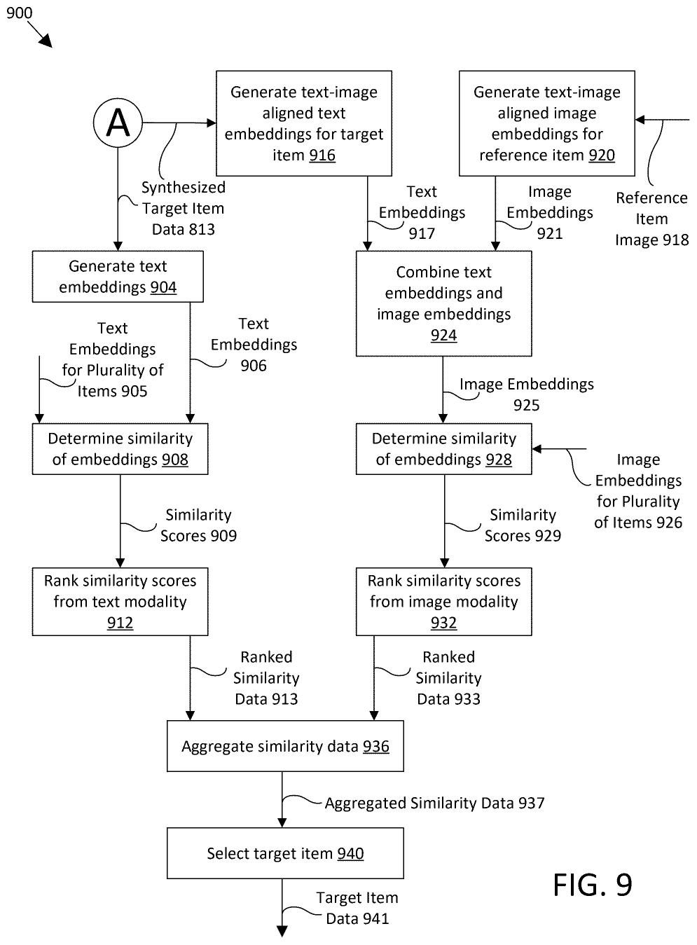

The chatbot 132 may be an application that uses the multi-modal pipeline 128. In some embodiments, the chatbot 132 is part of the model development platform 100. The chatbot 132 may also be part of a system to which the multi-modal pipeline 128 is deployed. In some embodiments, the chatbot 132 receives one or more queries from a user, processes the one or more queries, and outputs a response. The response may include item data, such as data for one or more reference items or one or more target items. Processing queries may include using the deployed multi-modal pipeline 128. Additionally, processing queries may include performing other operations, such as generating or preparing data that may be input into the multi-modal pipeline 128, an example of which is described in connection with FIGS. 8-9. In some embodiments, the chatbot 132 may include an agent for communicated with one or more of the models 120 or the multi-modal pipeline 128. In some embodiments, the chatbot 132 may be part of a shopping system, a recommender system, or search system. In such embodiment, the chatbot 132 may receive user queries submitted to an online retailer, and the chatbot 132 may return items from the retailer's catalog based on the user's queries. In some embodiments, the chatbot 132 may receive an initial query, the chatbot 132 may generate one or more recommended items (e.g., using the multi-modal pipeline 128) and present the one or more recommended items, the user may select one of the recommend item (e.g., as a reference item) and submit a follow-up query, the chatbot may generate one or more new recommended item (e.g., using the reference item and the follow-up query) and present these recommended items to the user. This process may continue until a user selects an item to purchase, which may be the target item. As described further herein, the chatbot 132 may be configured to receive diverse queries and generate a nuanced understanding of the item sought by the user due to the training of the multi-modal pipeline 128 using datasets generated by the dataset generation system 102.

FIG. 2 is a flowchart of an example method 200 that may be performed by components of the model development platform 100.

In the example shown, the dataset generation system 102 may generate a dataset (step 202). Example aspects of generating a dataset are described in connection with FIG. 3-6.

In the example shown, the dataset generation system 102 may evaluate the dataset (step 204). In some instances, the dataset generation system 102 my generate hundreds, thousand, tens of thousands, or hundreds of thousands of samples for a dataset. Accordingly, it may be impossible to manually verify the quality of such samples. Therefore, in example embodiments, the dataset generation system 102 automatically evaluate the dataset, which may include refining the dataset such that it includes only samples that are successfully validated during an evaluation process. In some embodiments, the dataset generation system 102 may use a cycle evaluation technique that includes using the multi-modal pipeline 128 to evaluate samples and then using validated samples to further train the multi-modal model. Details of example aspects of evaluating a dataset are further described in connection with FIG. 7.

In the example shown, the model training engine 130 trains the multi-modal model used in the multi-modal pipeline 128 (step 206). In some embodiments, the model training engine 130 uses a dataset that is validated by the dataset generation system 102 to train the multi-modal model in the multi-modal pipeline 128. In come embodiments, training the multi-modal model in the multi-modal pipeline 128 comprises freezing certain layers or parameters of the multi-modal model and then training a portion of the multi-modal model. In some embodiments, training the multi-modal model comprises learning parameters to accurately fuse the text and image modalities, such that the text and image data is mapped to a common latent space. In some embodiments, training the multi-modal model comprises using separate image and text encoders and combining their outputs through a cross-attention mechanism. Depending on the embodiment, the training objective for training the multi-modal model used in the multi-modal pipeline 128 may vary.

In some embodiments, training the multi-modal model in the multi-modal pipeline 128 may include using one or more of supervised, semi-supervised, or unsupervised training techniques, or a combination thereof. As an example of supervised learning, for a given sample, the multi-modal model may be trained to infer the target item, or to generate a target item embedding, based on the initial query, reference item, and follow-up query. Other training objectives are likewise possible. For example, the training objectives may include a contrastive loss that may include maximizing a similarity between text and image data of a sample. In some embodiments, the architecture of the multi-modal model may vary. For example, in a first embodiment, the multi-modal model may use a fusion layer to combine text embeddings and image embeddings, and training the multi-modal model may include training parameters of the fusion layer. In a second embodiment, however, the multi-modal model may not use such a fusion layer. Additionally, depending on the embodiment, the multi-modal model may use different base models, in which case the architecture and training of the multi-modal model may vary. Additional aspects of an example of training the multi-modal model are further described in U.S. patent application Ser. No. 18/317,593.

In the example shown, the multi-modal model in the multi-modal pipeline 128 may perform inference (step 208). For example, the multi-modal model may be deployed and may be integrated into a downstream system, examples of which are described in U.S. patent application Ser. No. 18/317,593. For example, the multi-modal pipeline 128 may be deployed as part of a multi-modal chatbot. When a user submits one or more of a query, reference item, or follow-up query to the multi-modal shopping chatbot, it may provide the data to the multi-modal pipeline 128 to generate target embeddings, which may be used to determine one or more target items. In some embodiments, the target embeddings are compared to a plurality of pre-computed embeddings for items, and one or more items with embeddings that are closest to the generated target embeddings may be selected as the one or more target items.

Depending on the embodiment, the multi-modal pipeline 128 may use different techniques for generating target embeddings, examples of which are described in connection with steps 210 and 212. In a first embodiment, the multi-modal pipeline 128 may use operations associated with step 210, whereas in a second embodiment, the multi-modal pipeline 128 may use operations associated with step 212. In some embodiments, the multi-modal pipeline 128 may use a combination of steps 210 and 212. As will be understood, performing inference with the multi-modal pipeline 128 may include more operations than performing either the step 210 or 212.

In the example shown, the multi-modal pipeline 128 may generate target embeddings based on initial query embeddings, reference item embeddings, and follow-up query embeddings (step 210). For example, the multi-modal pipeline 128 may determine a weighted sum of initial query embeddings (or conversation embeddings), reference item embeddings, and follow-up query embeddings in each modality to derive the target embeddings. Advantageously, such an approach enables efficient embedding generation.

In the example shown, the multi-modal pipeline 128 may generate target embeddings using generated target item data (step 212). For example, data for the target item may be generated using an LLM based on the reference item data and the follow-up query. Subsequently, text embeddings may be extracted and may mimic visual embeddings through the fusion of the visual embeddings of the reference item and the text-image aligned text embeddings derived from the generated target item data. Example aspects of generating target embeddings using the generated target item data are described further in connection with FIGS. 8-9.

FIG. 3 illustrates an example method 300 for generating a dataset. As described herein, the dataset generation system 102 may perform operations of the method 300.

In the example shown, the dataset generation system 102 may obtain a plurality of initial queries (step 302). For example, the dataset generation system 102 may access a plurality of initial queries from the query data 112. Moreover, the dataset generation system 102 may retrieve data associated with the initial queries from the query data 112. In some embodiments, retrieving initial queries comprises retrieving frequently used search queries based on historical data. For example, the dataset generation system 102 may retrieve the top X number (such as 100, 100, 1300, 13000, or another quantity) of queries based on the number of times that the queries, or slight modifications of the queries, were input into a digital retail system. In some embodiments, the dataset generation system 102 may retrieve queries having certain characteristics. For example, the plurality of initial queries may be between three to seven words. As another example, the plurality of initial queries may relate to a certain category of items, such as holiday items, groceries, toys and games, or another category. As another example, the plurality of initial queries may be associated with certain users, such as users that input the initial queries via a mobile application or users who ultimately did (or did not) purchase an item. In some embodiments, characteristic of the plurality of initial queries may depend on a downstream task of the multi-modal pipeline 128. For example, if the multi-modal pipeline 128 is being used in an apparel-specific task for clothes with a given characteristic, then the initial queries may be selected such that they correspond to clothes with or without that characteristic.

In the example shown, the dataset generation system 102 may generate a sample for the dataset (step 304). The dataset generation system 102 may repeatedly generate samples, either in parallel, in sequence, or a combination thereof, until the plurality of samples of the dataset are generated. In some embodiments, the dataset generation system 102 may generate one or more samples for each initial query of the plurality of initial queries received at the step 302. The operation 304 is described herein as being performed for a single sample; however, it may be repeatedly performed, as shown, to generate a plurality of samples.

In the example shown, the dataset generation system 102 may select an initial query (step 306). For example, the dataset generation system 102 may select an initial query from the initial queries received at the step 302.

In the example shown, the dataset generation system 102 may determine a reference item (step 308). For example, the dataset generation system 102 may select, as the reference item, an item from the item data 114 that matches the selected initial query. In some embodiments, the dataset generation system 102 may determine a plurality of items that correspond to the initial query and then select the reference item from among this plurality of items. In some embodiments, to determine one or more items that match the initial query, the dataset generation system 102 may generate embeddings for the initial query and compare these embeddings to a plurality of pre-computed embeddings associated with the items, selecting the pre-computed embeddings that are closest to the embeddings for the initial query. The pre-computed embeddings may be generated from one or more of text or image data associated with items. The dataset generation system 102 may identify the items that have embeddings that are closest to the embeddings of the initial query in a latent space. In some embodiments, the dataset generation system 102 may use a Cosine similarity. In some embodiments, to determine items that match the initial query, the dataset generation system 102 may identify attributes in the initial query and then identify items that have these attributes.

In the example shown, the dataset generation system 102 may determine a target item (step 308). In some embodiments, the target item is determined based on one or more modifications to the reference item. In some embodiments a nearest neighbor search for the reference item may be performed to determine the target item. For example, the nearest item embeddings to embeddings for the reference item may be identified, and one of the items corresponding to one of the nearest item embeddings may be selected. For example, if five items are identified as similar to the reference item, then one of the five items may be selected as the target item. For example, the target item may be selected randomly from a group of similar items to the reference items. In some embodiments, determining the target item may include modifying one or more attributes of the reference item and then identifying an item that includes the modified attribute. In some embodiments, determining a target item includes using each of the reference item and the initial query. For example, the target item may be selected such that it is at least a partial match with the initial query, and such that it shares at least some characteristics with the reference item but includes at least one modification from the reference item. In some embodiments, a multi-modal search using the initial query and reference item is used to determine the target item.

In the example shown, the dataset generation system 102 may generate a follow-up query (step 312). In some embodiments, the follow-up query is generated by using one or more of the LLM 122 or VLM 124. In some embodiments, the follow-up query may be generated based at least in part on differences between the determined reference item and the determined target item. Example aspects of generating a follow-up query are described in connection with FIGS. 4-6. In the example shown, the dataset may be output (step 314), such as to the dataset evaluator 108 or directly to the model training engine 130 or another component.

FIG. 4 is a flowchart of an example method 400 for generating a follow-up query. The method 400 illustrates an example for generating a follow-up query by determining differences between the reference and target item and using the differences to generate a follow-up query. Other techniques for generating a follow-up query are likewise possible. In some embodiments, the query generation agent 106 may perform aspects of the method 400. In the example shown, the query generation agent 106 may determine differences using text information and image information, respectively illustrated as steps 402 and 404. In some embodiments, these steps may be performed independently and in parallel, and the results may be combined. In some embodiments, some processes of the steps 402 and 404 may depend on data from the other step and therefore they may be executed sequentially at least in part.

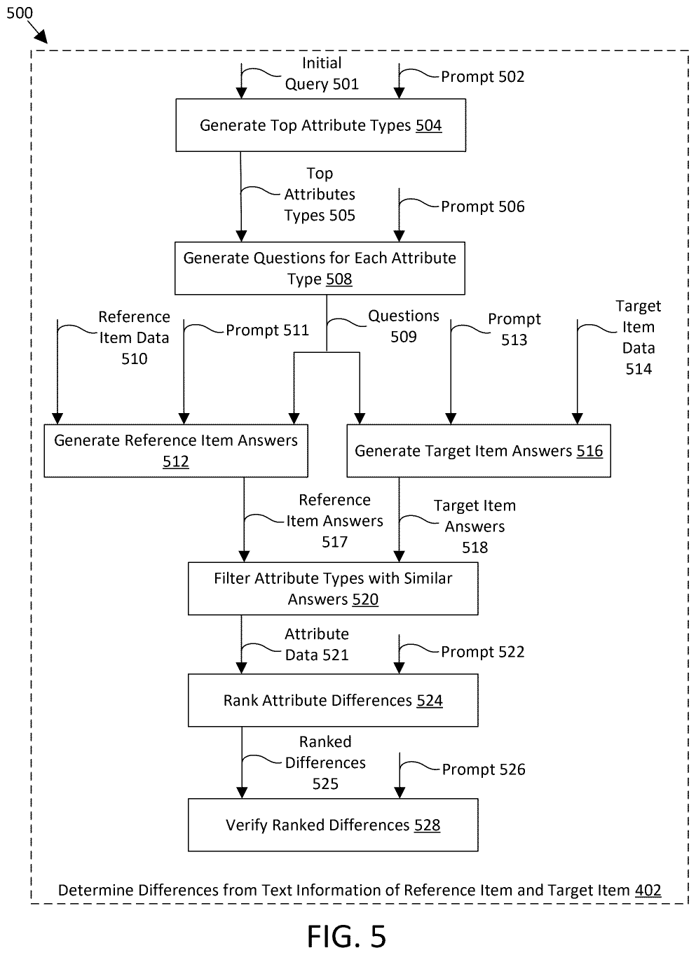

In the example shown, the query generation agent 106 may determine differences from text information of the reference item and target item (step 402). For example, the query generation agent 106 may repeatedly query the LLM 122 to, among other things, identify relevant and significant text-based differences between the reference and target item. An example of determining differences based on text data is further described in connection with FIG. 5.

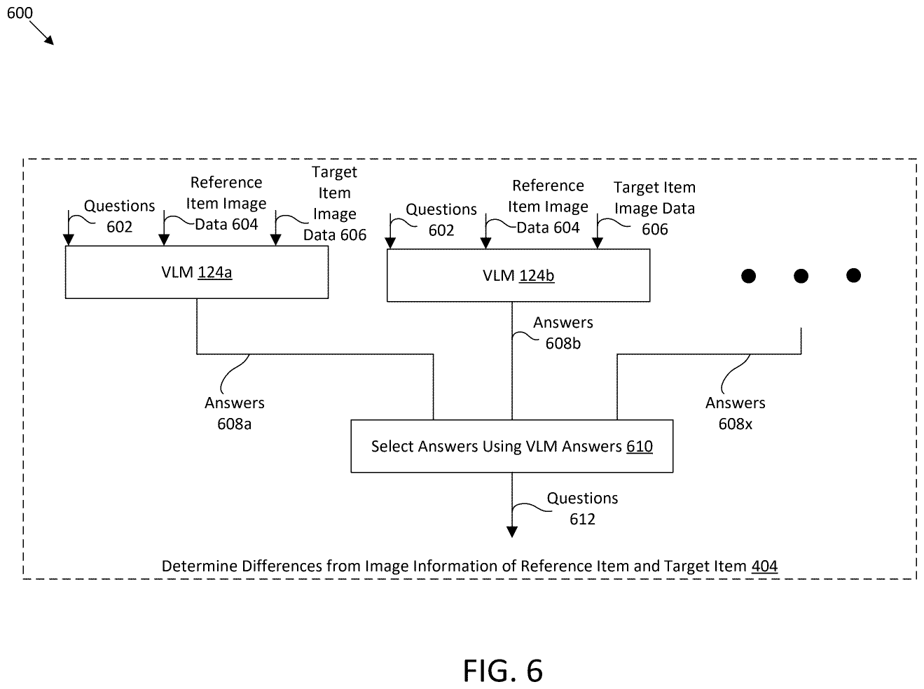

In the example shown, the query generation agent 106 may determine differences from image information of the reference item and target item (step 404). For example, the query generation agent 106 may use the VLM 124 to identify relevant and significant differences between the reference and target items. In some embodiments, this may include querying one or more VLMs 124 to perform a visual question answering task. An example of determining differences based on image data is further described in connection with FIG. 6.

In the example shown, the query generation agent 106 may convert differences to a follow-up query using a large language model (step 406). In some embodiments, the query generation agent 106 may produce a follow-up query by filling in pre-defined templates and using a LLM, such as the LLM 122, to refine the sentence and ensure it reads like a native speaker's query. In some embodiments, generating the follow-up query using the differences may be a multi-task process. For example, the query generation agent 106 may determine the relationships between the reference and target items based on the identified differences, which may include differences between various attribute types. In some embodiments, the query generation agent 106 may provide the LLM 122 with distinctive attribute values for the target and reference items for a particular attribute type. Using this information, the query generation agent 106 may prompt the LLM 122 to determine the relationship between the reference and target items. For example, the query generation agent 106 may prompt the LLM 122 to determine the change that occurs when moving from the reference item to the target item. Next, the query generation agent 106 may provide the LLM 122 the relationship in terms of each specific attribute type and prompt it to generate the follow-up query sentence. As part of doing so, the query generation agent 106 may provide examples to the LLM 122 for generating the follow-up query.

Advantageously, generating the follow-up query may include using significant differences between the reference item and target item from both a text and image modality and may use the learned parameters of a large pre-trained machine learning model to generate a query that is representative of a natural language user query. Therefore, the follow-up query may accurately mimic a diverse set of follow-up queries that reflect follow-up queries that human users may use when inputting modifications to the reference item to attain the target item.

FIG. 5 is a flowchart of an example method 500 for determining differences form text information of a reference item and a target item. As described herein, the method 500 may be performed by the query generation agent 106 and the LLM 122. For example, the method 500 illustrates the query generation agent 106 repeatedly prompting the LLM 122.

In the example shown, the query generation agent 106 may provide an initial query 501 and prompt 502 to the LLM 122 to generate a top number N of attribute types associated with the initial query 501 (step 504). The initial query 501 may be the initial query of the sample for which a follow-up query is being generated. As an example, the prompt 502 may instruct the LLM #6.592 to identify significant attribute types that users consider when searching for an item related to the initial query. The prompt 502 may be, for example, “You are a user searching for an item. You are searching for [insert initial query 501]. Based on this query, what are the top 5 most significant item attributes that you care about in your search?” The number of attribute types may vary depending on the embodiment. The LLM 122 may identify the top attribute types 505 and return them to the query generation agent 106. As an example, if the initial query is “sturdy matching set of kitchen chairs,” then the top attributes identified by the LLM 122 may be “price,” “dimension,” “material,” and “brand.”

In some embodiments, the determination of what attribute types qualify as “significant” or “top attribute types” is left to the LLM 122. For example, explicit criteria that defines significance may be intentionally omitted. Instead, the query generation agent 106 may advantageously rely on the LLM's understanding of what qualifies as a significant attribute with respect to the initial query. By using the LLM 122 to determine the top attributes, the knowledge of a pre-trained LLM 122 may be leveraged to generate top attributes quickly and accurately across diverse items of a collection of items. In some embodiments, resource-intensive and potentially mistaken human determinations of what qualifies as a “significant” attribute for a given query may advantageously be obviated. Accordingly, the determination of what attribute types are significant does not require a pre-defined or static definition for each item type. Moreover, the determination of what is significant can change as the parameters of the LLM 122 are changed to incorporate better training data and a changing information environment.

In the example shown, the query generation agent 106 may provide the top attribute types 505 and the prompt 506 to the LLM 122 to generate questions for each attribute type (step 508). In some embodiments, this is performed by providing all the attribute types to the LLM 122, whereas in some embodiments, the query generation agent 106 may individually provide the attribute types to the LLM 122. Continuing with the example above, the query generation agent 106 may prompt the LLM 122 to generate a non-binary question for asking for the “material” of kitchen chairs. In response, the LLM 122 may generate a question, such as “What material are these kitchen chairs made of?” Similarly, the LLM 122 may generate one or more questions for each of the attribute types and output the questions 509 to the query generation agent 106.

In the example shown, the query generation agent 106 may provide the questions 509, reference item data 510, and prompt 511 to the LLM 122 to generate reference item answers (step 512) and may provide the questions 509, prompt 513, and target item data 514 to the LLM 122 to generate target item answers (step 516). The reference item data 510 may be text data of the reference item, and the target item data 514 may be text data of the target item, examples of which are described in connection with FIG. 1. In some embodiments, the prompts 511 and 513 may be the same or similar prompts and may instruct the LLM to generate answers to the questions 509 using the reference item data 510 and the target item data 514, respectively. The LLM 122 may output reference item answers 517 and target item answers 518. Thereafter, the query generation agent 106 may prioritize differences between the reference item and the target item attributes in part by using the reference item answers and target item answers, example aspects of which are described in connection with the steps 520, 524, and 528.

In the example shown, the query generation agent 106 may filter attribute types with similar answers (step 520). For example, for each of the attribute types identified as significant to the initial query, or for each of the questions generated by the LLM 122, the query generation agent 106 may compare, using the answers 517 and 518, the respective attribute values for the reference item and target item. In some embodiments, the query generation agent 106 may filter out attribute types (which may include their corresponding attribute values and associated questions) that are sufficiently similar between the reference item and target item. For example, if the reference item is a first set of chairs and the target item is a second set of chairs with an attribute type of “material”, and if the first set of chairs has a corresponding attribute value of “Oak” and the second set of chairs has a corresponding attribute value of “Ash”, then the query generation agent 106 may filter out the attribute type of “material,” because there is not a significant difference between the “material” of the first set of chairs and the second set of chairs, which may indicate that a user would not submit a follow-up query to modify the material from the reference item to the target item. However, if the second set of chairs has an attribute value of “Steel” for “material”, then the attribute type of “material” may be retained, because the attribute values are significantly different.

Depending on the embodiment, different techniques may be used to assess attribute value similarity. As one example, a similarity score between attribute values may be generated and compared to a threshold. In some embodiments, the query generation agent 106 may generate embeddings for the attribute values and compare a distance between the respective embeddings to a threshold distance. In some embodiments, the query generation agent 106 may prompt a machine learning model to determine whether the attribute values would be significantly different for a user interested in the relevant item. In some embodiments, the query generation agent 106 may prompt the VLM 124 to determine whether the attribute values are significantly different from a visual perspective. Each of these techniques may ultimately compare attribute value similarity to a threshold value. Other techniques are likewise possible.

Advantageously, by selecting attribute types for which the attribute values are significantly different, the query generation agent 106 may generate follow-up queries that more faithfully mimic user behavior, as opposed to generating follow-up queries that relate to attribute types with values that, while superficially may differ, would likely not be considered sufficiently different by a user.

In the example shown, the query generation agent 106 may provide attribute data 521 and a prompt 522 to the LLM 122 to rank attribute differences (step 524). The attribute data 521 may include an output from the step 520. For example, the attribute data 521 may include attribute types and values that were determined to be significantly different between the reference item and target item. The prompt 522 may instruct the LLM 122 to rank the differences by significance based on a side-by-side attribute value comparison regarding each attribute type that was identified as significant (e.g., at the step 504) and that was not filtered (e.g., at the step 520). The LLM 122 may output a list of different attributes ranked by significance to a user interested in the reference item or target item. In some embodiments, the LLM 122 may also output a significance score.

In the example shown, the query generation agent 106 may provide the ranked differences 525 and a prompt 526 to the LLM 122 to verify the ranked differences (step 528). The query generation agent 106 may prompt the LLM 122 to detect any conflict in the ranking and revise if necessary to ensure consistency and accuracy of the identified attribute types, their corresponding attribute values, and the significance-based rankings.

FIG. 6 is a flowchart of an example method 600 for determining differences from image information of the reference item and target item. As described herein, the method 600 may be performed by the VLM 124, which may be one or more VLMs 124a-x, and by the query generation agent 106. For example, the method 600 illustrates the query generation agent 106 prompting a plurality of VLMs 124.

In the example shown, the query generation agent 106 provides questions 602, reference item image data 604, target item image data 606 to VLM 124a and VLM 124b, which may be different instances of a same VLM or different VLMs. Additionally, the query generation agent 106 may provide the questions 602, reference item image data 604, and target item image data 606 to additional VLMs.

For example, the query generation agent 106 may prompt the VLM 124a to perform one or more visual question answering tasks using the questions 602, reference item image data 604, and target item image data 606. In some embodiments, the questions 602 are or include the questions 509 described in connection with FIG. 5. The questions 602 may include questions about the reference item and target item. The questions 602 may vary depending on attributes of the items. As an example, a question of the questions 602 may be “What color is this chair?” or “Where in a house would this chair likely be placed?”. The questions 602 may include one or more questions for each of a plurality of attribute types, and the VLM 124a may generate an answer to the question for each of the reference item and the target item using the reference item image data and the target item image data, respectively. These answers may be output as the answers 608a. The VLM 124b may be prompted to perform a same or similar task and may output the answers 608b. In some instance, the answers output by the VLMs 124a-x may differ, since they are generated by different models. In some embodiments, the VLMs 124a-x may be prompted to perform different or additional image-related tasks, such as identifying significant differences, and the degree of such differences, between the reference item image data 604 and the target item image data 606.

In the example shown, the query generation agent 106 may select answers using VLM answers (step 610). For example, the query generation agent 106 may select answers to the questions 602 using candidate answers 608a, 608b, and so on, generated by the VLMs 124a, VLM 124b, and so on, respectively. In some embodiment, the query generation agent 106 may select the most frequent answer generated by the VLMs 124a-x. For instance, if a question is “What is the color,” and if three VLMs answered “beige” for the reference item and two VLMs answered “brown” for the reference item, then the VLM may select the answer “beige.” In some embodiments, multiple answers may be selected or candidate answers from different VLMs may be combined to generate an answer. In some embodiments, the query generation agent 106 may use the selected answers to filter or rank differences between the reference item and target item, example aspects of which are described in connection with the steps 520 and 524 of FIG. 5. Additionally, the query generation agent 106 may use one or more of the text differences and image differences between the reference item and target item to generate a follow-up query.

FIG. 7 is flowchart of an example method 700 for evaluating a dataset. In some embodiments, the dataset generation system 102 may use one or more of the dataset evaluator 108, the models 120, or the multi-modal pipeline 128 to perform operations of the method 700.

In the example shown, the dataset generation system 102 may access a dataset (step 702). For example, the dataset may include samples previously generated by the dataset generation system 102. In some embodiments, a dataset generated by the dataset generation system 102 may be separated for different purposes. For example, a first subset may be used for validating the multi-modal model in the multi-modal pipeline 128, and a second subset may be used for training the multi-modal model in the multi-modal pipeline 128. In some embodiments, the dataset generation system 102 may retrieve a training dataset to evaluate, which may include thousands or millions of samples.

In the example shown, the dataset generation system 102 may evaluate each sample of the retrieve dataset. In the example shown, the dataset generation system 102 may select a sample, which may include an initial query, a reference item, a follow-up query, and a target item (step 704).

In the example shown, the dataset generation system 102 may use the multi-modal model to infer a target item for the sample (step 706). The dataset generation system 102 may input the initial query, reference item, and follow-up query into the multi-modal pipeline 128. In some embodiments, this is performed by inputting the data into a chatbot that serves as an interface for the multi-modal pipeline 128. In response, the multi-modal pipeline 128 may process the received input data and infer a target item. In some embodiments, the multi-modal pipeline 128 generates target item embeddings and determines nearest neighbors to the target embeddings. The target item may be an item with embeddings that are closest to the generated target item embeddings. In some embodiments, the multi-modal pipeline 128 may return the target embeddings, or the multi-modal synthesized 128 may return a particular synthesized target item data or a plurality of synthesized data for target items.

In the example shown, the dataset generation system 102 can determine whether the inferred target item matches the target item of the sample (step 708). Depending on the embodiment, the dataset generation system 102 may perform different operations to determine whether the inferred target item matches the target item of the sample. For example, the dataset generation system 102 may determine whether an item identifier determined using data generated by the multi-modal pipeline 128 matches an identifier of the target item identifier of the sample. In some embodiments, the dataset generation system 102 may determine whether target item embeddings generated by the multi-modal pipeline 128 are sufficiently similar (e.g., within a predetermined threshold distance) to embeddings for the target item of the sample. In some embodiments, such as when a plurality of the synthesized target items are determined using the multi-modal pipeline 128, the dataset generation system 102 may determine whether the synthesized target item of the sample corresponds to one of the target items.

In response to determining that the inferred target item matches the target item of the sample (e.g., taking the “YES” branch), the dataset generation system 102 may add the sample to a dataset with validated samples (step 710). In response to determining that the inferred target item does not match the target item of the sample (e.g., taking the “NO” branch), the dataset generation system 102 may filter out the sample from a dataset of validated data (step 712).

In some embodiments, samples that are filtered out of the validated dataset are added to a dataset with invalid samples. In some embodiments, the dataset generation system 102 may determine a new reference item, a new target item, or a new follow-up query for these samples. In some embodiments, only a new follow-up query is determined. In some embodiments, samples that are not successfully validated (e.g., invalid samples) may be reevaluated at a subsequent time. For example, one or more of the operations of the method 700 may be performed again for the samples after the multi-modal pipeline 128 is further trained using samples from the validated training set. As another example, the samples may be reevaluated after a new follow-up query is generated for the samples.

In the example shown, the dataset generation system 102 may determine whether there is another sample to evaluate (step 714). If so, the dataset generation system 102 may return to the step 704 (e.g., taking the “YES” branch). If not, the dataset generation system 102 may proceed to the step 716 (e.g., taking the “NO” branch). In the example shown, the dataset generation system 102 may output the validated dataset (step 716). For example, the dataset generation system 102 may output the plurality of validated samples to the model training engine 130.

FIG. 8 is a flowchart of an example method 800 for generating target item data. In some embodiments, the multi-modal pipeline 128 may generate target item embeddings using synthesized target item data, example aspects of which are described in connection with operation 212 of FIG. 2 and further in connection with the method 900. In some embodiments, a component communicatively coupled with a deployed multi-modal pipeline 128 may perform aspects of the method 800. For example, the chatbot 132 or another application may perform operations of the method 800 by using a large language model, such as the LLM 122. Although steps of the method 800-900 are described herein as being performed by the chatbot 132, they are not limited to being performed by the chatbot 132 and can be performed by one or more other components. In the example shown, the chatbot 132 may have received a follow-up query 801 that refers to a reference item. The example method 800 illustrates an example for determining target item data using the follow-up query 801 and reference item data 807.

In the example shown, the chatbot 132 may provide the follow-up query 801 and the prompt 802 to the LLM 122 to determine attribute types and query preferences (step 804). For example, the follow-up query 801 may specify one or more attribute types that are to be modified. For instance, if the follow-up query is “this size, but in a different color and with long sleeves,” then the attribute types that may be identified by the LLM 122 may be the color and style of sleeves. Additionally, the prompt 802 may instruct the LLM 122 to not only identify the attribute types but also to identify the preferred attribute values for the attribute types as set forth in the follow-up query 801. In response, the LLM 122 may output the attribute types 805 and preferences 811.

In the example shown, the chatbot 132 may provide the attribute types 805, prompts 806, and reference item data 807 to the LLM 122 to determine reference item phrases corresponding to the attribute types (step 808). For example, the reference item data 807 may include text metadata of the reference item. The meta-data may include one or more of a description of the reference item or characteristics of the reference item, such as a table that lists attribute types and attribute values for the reference item. The prompt 806 may instruct the LLM 122 to detect phrases existing in the reference item metadata corresponding to each of the attribute types 805. For example, the LLM 122 may identify the relevant location in a table corresponding to a given attribute type. As another example, the LLM 122 may identify a certain clause in an item description that corresponds to a given attribute type. The LLM 122 may output detected reference item phrases 809 corresponding to the attribute types.

In the example shown, the chatbot 132 may provide reference item data 807, reference item phrases 809, a prompt 810, and preferences 811 to the LLM 122 to generate target item data (step 812). For example, given the reference item metadata, detected target phrases regarding each attribute type to be updated, and the preferences detected in the follow-up query, the LLM 122 may generate target item data by replacing data in the reference item phrases 809 with data from the preferences 811, thereby generating item data that is modified using preferences detected in the follow-up query 801, resulting in synthesized target item data 813. In some embodiments, the synthesized target item data 813 may be metadata that retains certain structure and content of the reference item metadata but that is modified to incorporate the query preferences. In the example shown, the synthesized target item data 813 is subsequently provided to the multi-modal pipeline 128 (e.g., as shown by the numeral “A”), as described further in connection with FIG. 9.

FIG. 9 is a flowchart for a method 900 for generating target item embeddings. As described herein, aspects of the method 900 may be performed by the multi-modal pipeline 128. Additionally, other components, such as one or more of the models 120 or the chatbot 132 may perform one or more of the operations of FIG. 9. In some embodiments, execution of the operations of FIG. 9 may be coordinated by the chatbot 132 and performed by other components.

In the example of FIG. 9, text embeddings and image embeddings may be generated for the target item. For example, once the synthesized target item data 813 is generated using LLMs, text embeddings can be directly extracted from the synthesized target item data 813 by utilizing a text embedding model, which enables item retrieval from the text modality. Additionally, multimodal item retrieval, which combines both text and image modalities, may be used, as shown in FIG. 9. For example, in image-based retrieval, target image embeddings may be extracted to find a best match among images of all items. However, since the synthesized target item data 813 may not, in some instances, include an image, the image-based retrieval problem is addressed as a text-conditioned image retrieval problem instead.

Continuing with the example of FIG. 9, in an embodiment of the text-conditioned image retrieval system, the target image embedding is generated by combining the text-image aligned image embeddings from the reference item and the text-image aligned text embeddings derived from the synthesized target item data 813. In some embodiments, a combiner is used that involves a weighted sum operation. In some embodiments, a fusion model is used to combine the reference item image embeddings and target item text embeddings. For example, the fusion model may better capture contextual relationships between text and image modalities, and ultimately generate image embeddings that more faithfully represent the combination of target item text data and reference item image data. In some embodiments, the fusion model is trained using datasets generated by the dataset generation system 102 to improve the accuracy and effectiveness of the text-conditioned image retrieval system.

In the example shown, a text embedding model may generate text embeddings 906 for the synthesized target item data 813 (step 904). In some embodiments, the LLM 122 may generate the text embeddings.

In the example shown, the chatbot 132 may compare text embeddings for a plurality of items 905 and the text embeddings 906 to determine the similarity of embeddings (step 908). The text embeddings for the plurality of items may be a plurality of pre-computed text embeddings for a plurality of items in a retailer catalog. Such embeddings may be generated by a same model that generates the text embeddings for the synthesized target item data 813. In some embodiments, determining the similarity of embeddings comprises determining distances between the text embeddings 906 and the embeddings of the text embeddings for the plurality of items 905. In some embodiments, similarity scores 909 may be generated, wherein the closer the embeddings in a latent space, the higher the similarity score.

In the example shown, the chatbot 132 may rank similarity scores from the text modality (step 912). For example, the chatbot 132 may rank items from the plurality of items based on the similarity scores determined at the step 908, and ranked similarity data 913 may be output so it can be aggregated with similarity data derived from the image modality.

In the example shown, an encoder may generate text-image aligned text embeddings 917 for the target item by using the synthesized target item data 813 (step 916). In some embodiments, a text-image aligned machine learning model such as CLIP text encoder, or a model that shares at least some features with the CLIP text encoder, is used.

In the example shown, an encoder may generate text-image aligned image embeddings 921 for the reference item by using reference item image data 918 (step 920). In some embodiments, a text-image aligned machine learning model such as CLIP image encoder, or a model that shares at least some features with the CLIP image encoder, is used.

In the example shown, a combiner may combine the text-image aligned text embeddings 917 and the text-image aligned image embeddings 921 (step 924). In some embodiments, the combiner applies a weighted sum to the embeddings 917 and 921. In some embodiments, the combiner applies the multi-modal machine learning model 128, which may fuse the text embeddings 917 and image embeddings 921 to generate the embeddings 925. As shown, the combiner may output the image embeddings 925.

In the example shown, the chatbot 132 may compare image embeddings for a plurality of items 926 and the image embeddings 925 to determine the similarity of embeddings (step 928). The image embeddings for the plurality of items 926 may be a plurality of pre-computed image embeddings for a plurality of items in a retailer catalog. Such embeddings may be generated by a same model that is aligned to generate embeddings in a same latent space as the image embeddings 925. In some embodiments, determining the similarity of embeddings comprises determining distances between the image embeddings 925 and the embeddings of the image embeddings for the plurality of items 926. In some embodiments, similarity scores 929 may be generated, wherein the closer the embeddings in a latent space, the higher the similarity score.

In the example shown, the chatbot 132 may rank similarity scores from the image modality (step 932). For example, the chatbot 132 may rank items from the plurality of items based on the similarity scores determined at the step 928, and ranked similarity data 933 may be output so it can be aggregated with similarity data derived from the image modality.

In the example shown, the chatbot 132 may aggregate similarity data (step 936). For example, the chatbot 132 may aggregate ranked similarity 913 from the text modality and ranked similarity data 933 from the image modality to generate aggregated similarity data 937. In some embodiments, the chatbot 132 may determine a weighted sum over the similarity scores from the two modalities. In some embodiments, the output aggregated similarity data 937 includes one or more of a list of item identifiers, a list of item embeddings corresponding to item identifiers, or a list of similarity scores corresponding to items. In some embodiments, the aggregated similarity data 937 includes a ranked list of items.

In the example shown, the chatbot 132 may select a target item using the aggregated similarity data 937 (step 940). In some embodiments, the chatbot 132 may determine a plurality of target items. In some embodiments, the chatbot 132 selects the top one or more items from a ranked list of items in the aggregated similarity data 937 as the one or more target items. In some embodiments, the chatbot 132 outputs the target item data 941, which may include text or image information for the one or more selected items. For example, the chatbot 132 may display the target item data 941 to a user.

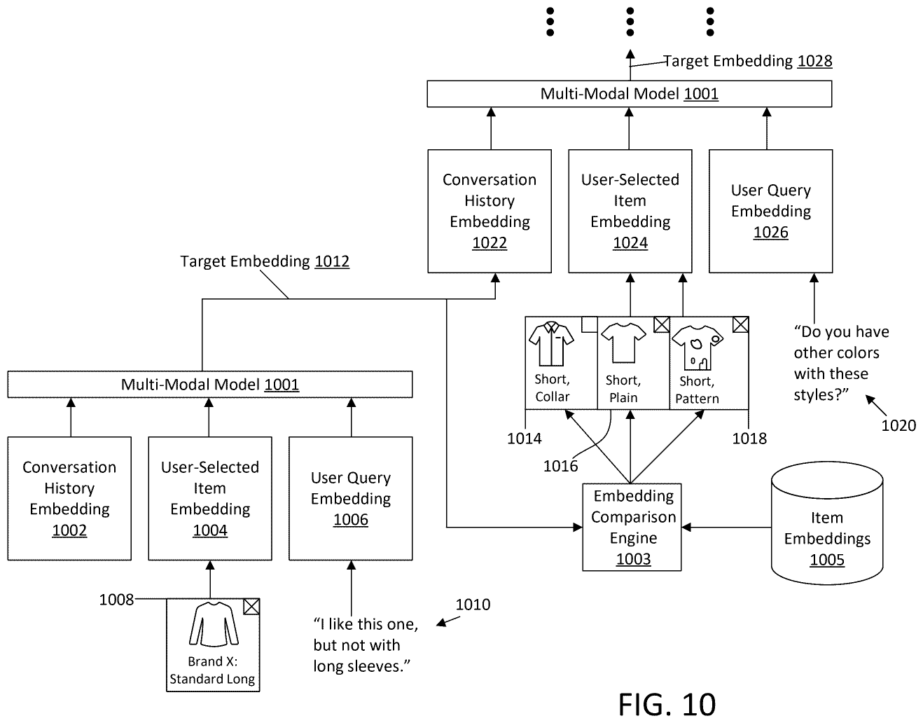

FIGS. 10-12 illustrate example applications associated with a multi-modal model that may be trained using a dataset generated using techniques disclosed herein. For example, the multi-modal model 1001 described in connection with FIGS. 10-12 may be trained using a dataset generated in connection with the operation 206 and associated operations. The multi-modal model 1001 may be an example of the multi-modal pipeline 128 of FIG. 1. FIGS. 10-12 further illustrate an example integration of the multi-modal model 1001 into a recommender system that includes a multi-modal chat bot, such as the chatbot 132 described in connection with FIG. 1.

Referring to the schematic example of FIG. 10, the multi-modal model 1001 may receive, as input, a conversation history embedding 1002, a user-selected item embedding 1004, and a user query embedding 1006. In some instances, there may not be a conversation history embedding, such as when a user first begins a session. The user-selected item embedding 1004 may be an embedding generated for the selected item 1008. In some instances, a user may have selected the item 1008 via a user interface. In some embodiments, the selected item 1008 may have been recommended by the recommender system to the user during a previous iteration. In some embodiments, the user-selected item embedding 1004 may have been previously determined by the model 1001. The user-selected item embedding 1004 may reflect both visual data of the item 1008 (e.g., one or more images) and textual data of the item 1008 (e.g., a title, description, metadata including attributes, etc.).

The user query embedding 1006 may be an embedding for the user query 1010. In some embodiments, the recommender system may receive the user query 1010 via a user interface, and the user may have sent the user query in connection with the selection of the item 1008.

Based on the inputs 1002-1006, the model 1001 may output the target embedding 1012. In the example shown, the target embedding 1012 may be provided to the embedding comparison engine 1003, and the target embedding 1012 may be set as the conversation history embedding 1022 as an input for a next iteration and inference of the model 1001.

The embedding comparison engine 1003 may receive the target embedding 1012 and compare it to item embeddings in the item embedding database. Based at least in part on the comparison, one or more items may be selected to recommend to the user. In the example shown, the items 1014, 1016, and 1018 are recommended. Similar to the item 1008, each of the items 1014-1018 is a shirt, but they do not have long sleeves, illustrating that the target embedding 1012 generated by the model 1001 accounted for the user query 1010 which indicated that long sleeves were not wanted. In some embodiments, aspects of each of the recommended items 1014-1018 may be displayed to a user (e.g., via a user interface). As shown in the upper-right corner of each of the recommended items 1014-1018, a user may be able to select one or more of the recommended items as part of communicating with the recommender system. Yet still, in some embodiments, each of the recommended items 1014-1018 may also be associated with other interactive components, such as a button or input field to purchase the item. In the example of FIG. 10, a user selects the item 1016 and the item 1018, and the user inputs the user query 1020.

As mentioned above, the conversation history embedding 1022 may be the target embedding generated by the model 1001 in the previous iteration (e.g., the target embedding 1012). As a result, the conversation state, which may include the user queries and the recommended or user-preferred items, may be passed from iteration to iteration, thereby giving the recommender system a mechanism for remembering previous data from the session. In examples, the conversation history embedding 1022 may include not only the target embedding 1012, but may also include a target embedding for an iteration prior to the iteration in which the model 1001 generated the target embedding 1012. As discussed above, the one or more target embeddings that represent one or more conversation states of the conversation history may be weighed (e.g., giving a higher weigh to target embeddings generated in more recent iterations than to target embeddings generated during other iterations).

The user-selected item embedding 1024 may be an embedding that represents each of the user-selected items (e.g., the item 1016 and 1018). In some embodiments, the embeddings for the selected items 1016-1018 may be averaged. In other embodiments, the embeddings for the selected items 1016-1018 may be combined in a different manner. The user query embedding 1026 may be an embedding for the user query 1020. In the example of the FIG. 10, the model 1001 may receive the inputs 1022-1026 and output the target embedding 1028, thereby proceeding to a subsequent iteration involving the recommender system and chatbot.

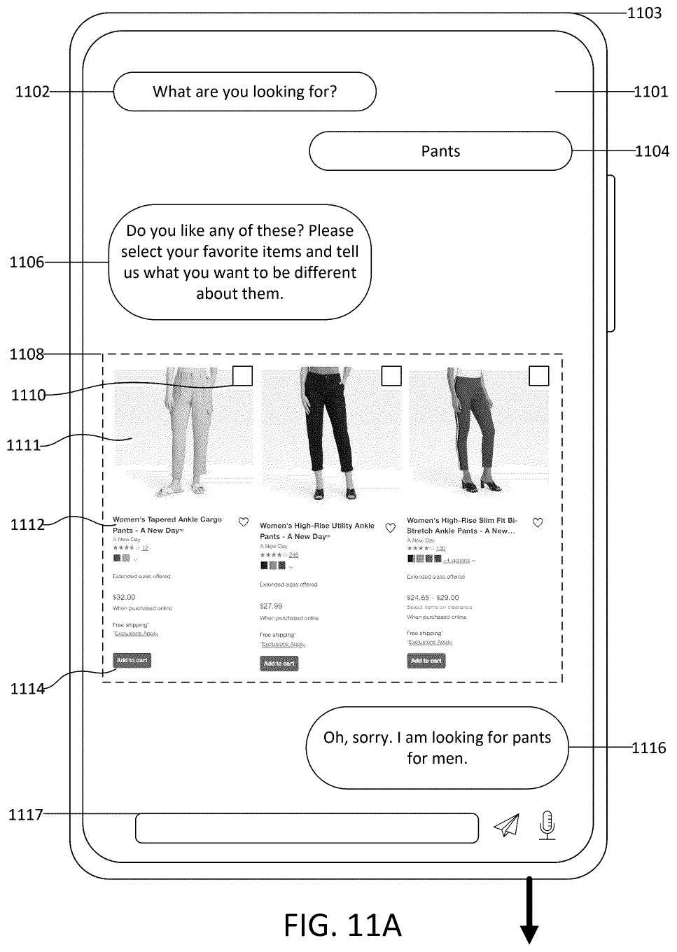

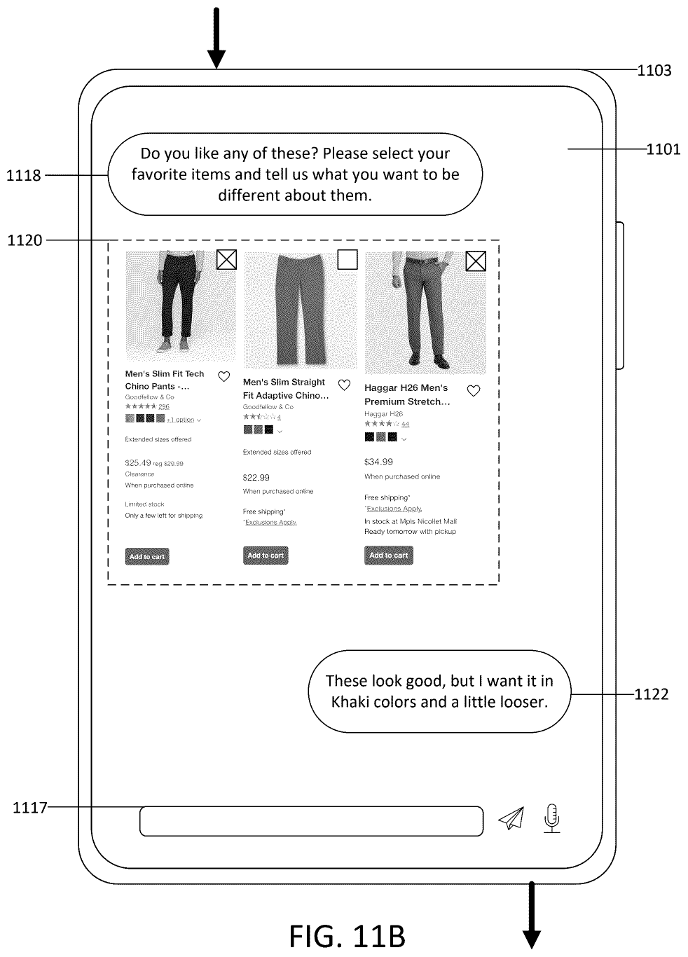

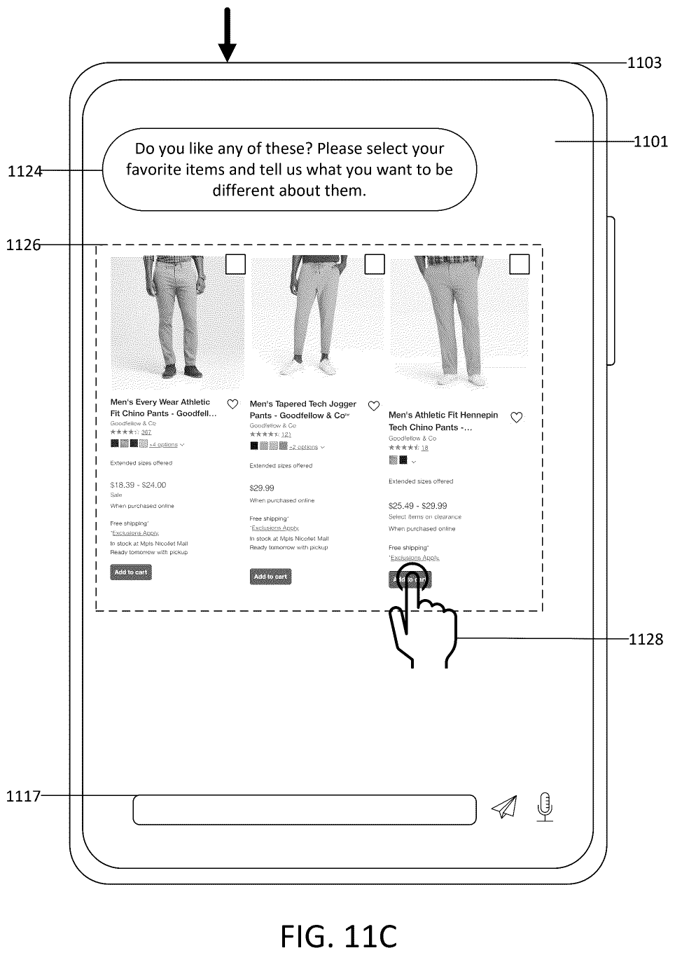

FIGS. 11A-11C illustrate a further example use of aspects of a recommender system that may use the chatbot 132 and multi-modal 1001, which may be an example of a model trained using a dataset generated according to techniques described herein. The examples of FIGS. 11A-11C depict a single recommendation session, as illustrated by the bold arrows leading to and from the device 1103. In the example of FIGS. 11A-11C, a user of the device 1103 may access the recommender system, and the recommender system may provide the user interface 1101, which may be displayed by a screen of the device 1103. With respect to the dialogue illustrated in the examples of FIGS. 11A-11C, text from the recommender system is illustrated on the left side of the user interface 1101, and user queries are illustrated on the right side of the user interface 1101. Furthermore, in the examples shown, a user may input queries using the input field 1117. In some embodiments, the user queries may use a physical or digital keyboard to type text into the input field 1117. In some embodiments, a user may use a microphone of the device 1103 to input an audio query.

In FIG. 11A, the recommender system may output the text 1102 at the beginning of a recommendation session. As shown, the text 1102 may be a prompt, asking “What are you looking for?” to the user. In other examples, the recommender system may generate other text to begin a recommendation session. In the example shown, the user may input the user query 1104, indicating that the user is looking for “Pants.”

In some embodiments, the recommender system may select one or more items to recommend based on the user query 1104. For instance, at the start of a recommendation session, there may not be any selected user-preferred items, and there may not be a conversation history. In some embodiments, the recommender system may generate an embedding for the user query 1104 and then input the embedding for the user query 1104 into the multi-modal model 1001. In some embodiments, the recommender system may use another model or process for recommending items when there is no conversation history or no selected user-preferred items.

Continuing with the example of FIG. 11A, the recommender system may, in response to the user query 1104, recommend the items 1108. In the example of FIG. 11A, the items 1108 include three items, each of which are pants for women. In addition to displaying the items 1108, the recommender system may also output the text 1106. In the example of FIG. 11A, although labeled for only the left-most item, each of the items 1108 includes a selection field 1110, an image 1111, text 1112, and a link 1114 to add an item to an online or digital shopping cart. The selection field 1110 may be clicked or touched by the user as part of interacting with the recommender system to determine more refined recommendations. The text 1112 may include a description and title of the item. Furthermore, although not illustrated, each of the items may include attributes. The attributes may be metadata for the item. In some embodiments, a selection of the link 1114 will add the corresponding item to an online shopping cart. In some embodiments, a selection of the link 1114 will direct a user to a check out process. The user query 1116 indicates that the user wants to receive more recommendations. As shown, the user did not select any of the items 1108 as part of continuing to search for more recommendations.

The example of FIG. 11B follows from the example of FIG. 11A. As shown in FIG. 11B, the recommender system determines new items 1120 to recommend based on, for example, the user query 1116 and a target embedding used to select the items 1108. Additionally, the recommender system also generates and displays the text 1118. As shown, the user selects two items of the items 1120 (as illustrated by the ‘X’s in the upper-right corner of two of the recommended items 1120) and inputs a user query 1122.

In some embodiments, the recommender system may, using the selected items of the items 1120, the user query 1122, and the conversation history, determine an updated set of recommendations. For example, as shown, in the example of FIG. 11C, the recommender system may recommend the items 1126. Along with the recommended items 1126, the recommender system may also output the text 1124. In the example shown, the user may purchase one or more of the recommended items. For example, as shown by the selection (e.g., click or touch) of the right-most item of the items 1126, the user may select a button or purchase link to add the item to an online shopping cart.

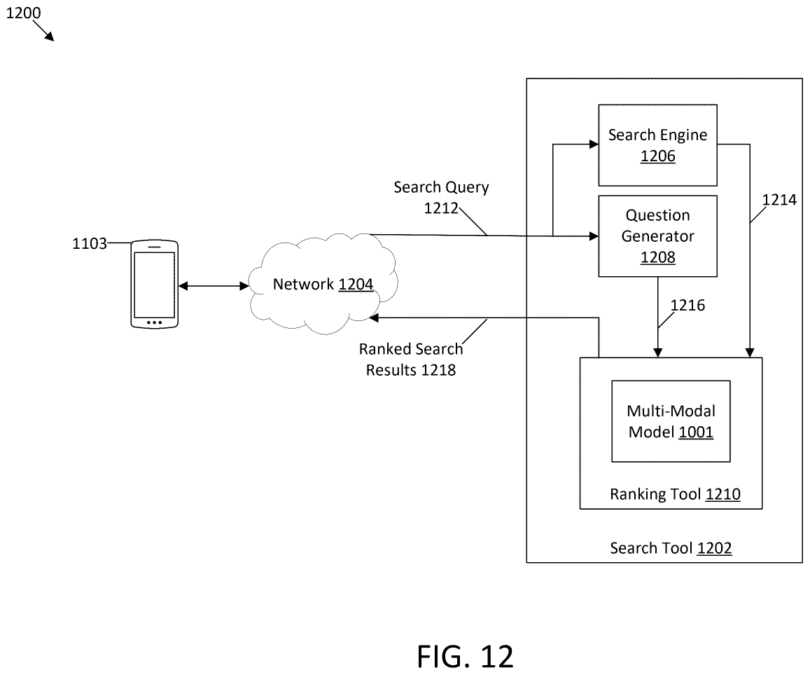

In the example of FIG. 12, the multi-modal model 1001 is integrated with a search tool 1202. Specifically, the multi-modal model 1001 is fine-tuned to rank search results by performing a visual question answer task for items of the search results. FIG. 12 illustrates an example network environment 1200 in which a search tool 1202 may be implemented. The environment 1200 includes the device 1103, the search tool 1202, and a network 1204.

The search tool 1202 includes a search engine 1206, a question generator 1208, and a ranking tool 1210, which may use the multi-modal model 1001. In some embodiments, the search tool 1202 may be accessed via a website or a mobile application. For example, a search feature offered by a website or mobile application may call the search tool 1202 to perform a search in response to receiving a user query. The search engine 1206 may be a system or service that receives a query and returns one or more results. In some embodiments, the search engine 1206 may return one or more retail items. The question generator 1208 may receive a search query and generate one or more questions based on the query. For example, if the query is “crewneck green shirts,” then the question generator may generate the following question: “what is the color of the shirt?”; “what is the person wearing on top?”; “what is the collar style of the apparel?”; “is the color green?”; “is the color red?”; and so on, generating binary and non-binary questions that may relate to the query. In examples, the question generator 1208 may also generate answers for each of the question. For example, for the question “what is the collar style of the apparel,” the answer may be “crew neck,” based on the search query received by the question generator 1208. As another example, for the question “is the color red,” the answer may be “no” or “false.” In an example, the question generator 1208 may use one or more question templates used to create question-answer-image triplets as part of generating training data from training instances. The ranking tool 1210 may rank search results. To do so, the ranking tool 1210 may include one or more components, such as the multi-modal model 1001.

The elements 1212-1218 illustrate an example use of the search tool 1202. In the example shown, a user of the device 1103 may provide a search query 1212 to the search tool 1202. In the example shown, the search query 1212 may be directed to both the search engine 1206 and the question generator 1208. The search engine 1206 may perform a search operation using the search query and generate a plurality of search results 1214. The plurality of search results 1214 may be a plurality of search items returned in response to the search query 1212. In the example shown, the search engine 1206 may provide the search results 1214 to the ranking tool 1210. In the example shown, the question generator 1208 may receive the search query 1212, generate a plurality of question 1216 using the search query 1212, and provide the plurality of questions to the ranking tool 1210. In examples, the question generator 1208 may also generate answers for each of the question. The answers may be based on the search query received by the question generator 1208, and the question generator 1208 may provide the answers along with the questions to the ranking tool 1210.

In some embodiments, the ranking tool 1210 may receive the search results 1214 and the questions 1216, and the ranking tool 1210 may rank the search results 1214 using the multi-modal model 1001. To do so, the multi-modal model 1001 may perform a visual question answering task using the search results 1214 and the questions 1216. For example, the multi-modal model 1001 may, for each item of the search results 1214, answer the questions 1216. With each answer, the multi-modal model 1001 may generate a confidence score. For each item, the confidence scores for each of the questions 1216 may be averaged. The average confidence score for an item of the results 1214 may be compared to confidence scores of other items of the 1214, and the items may be ranked based on the confidence scores. For example, if the multi-modal model 1001 has a relatively high average confidence score when answering the questions 1216 for an item, then that item may be ranked higher than an item for which multi-modal model 1001 did not have such a confidence score. In some embodiments, the confidence scores and the multi-modal model 1001 may be used in a different manner for ranking the search results 1214. In the example shown, the search tool 1202 may provide ranked search results 1218 to the device. In some embodiments, the ranked search results 1218 may be one or more of the items in the results 1214, ranked according to an order determined by the ranking tool 1210. In some embodiments, the ranked search results 1218 may be displayed in a user interface of the device 1103.

The network 1204 may be, for example, a wireless network, a wired network, a virtual network, the internet, or another type of network. Furthermore, the network 1204 may be divided into subnetworks, and the subnetworks may be different types of networks or the same type of network. In different embodiments, the network environment 1200 can include a different network configuration than shown in FIG. 12, and the network environment 1200 may include more or fewer components than those illustrated.

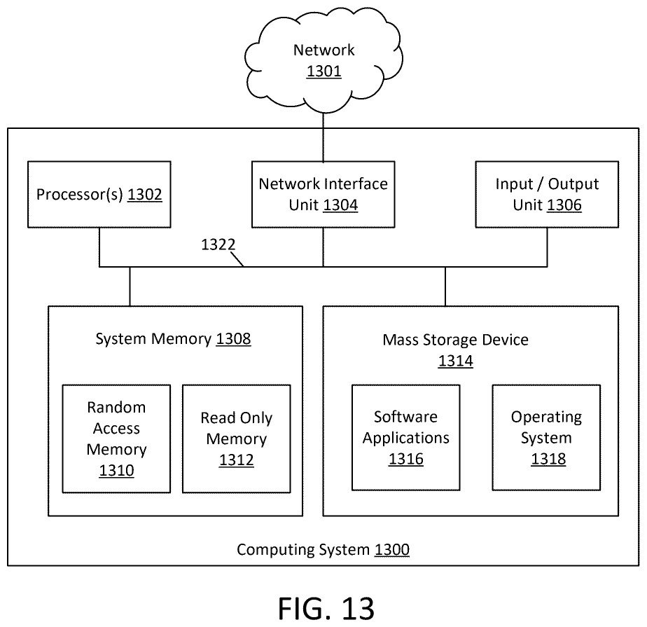

FIG. 13 illustrates an example block diagram of a virtual or physical computing system 1300. One or more aspects of the computing system 1300 can be used to implement the systems and processes described herein. For example, the disclosed computing system 1300 provides a physical environment within which aspects of the present disclosure may be implemented. For example, the computing system 1300 may represent an environment in which the model development platform 100 or one or more components thereof may be implemented.

In the embodiment shown, the computing system 1300 includes one or more processors 1302, a system memory 1308, and a system bus 1322 that couples the system memory 1308 to the one or more processors 1302. The system memory 1308 includes RAM (Random Access Memory) 1310 and ROM (Read-Only Memory) 1312. A basic input/output system that contains the basic routines that help to transfer information between elements within the computing system 1300, such as during startup, is stored in the ROM 1312. The computing system 1300 further includes a mass storage device 1314. The mass storage device 1314 is able to store software instructions and data. The one or more processors 1302 can be one or more central processing units or other processors.

The mass storage device 1314 is connected to the one or more processors 1302 through a mass storage controller (not shown) connected to the system bus 1322. The mass storage device 1314 and its associated computer-readable data storage media provide non-volatile, non-transitory storage for the computing system 1300. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1300.

According to various embodiments of the invention, the computing system 1300 may operate in a networked environment using logical connections to remote network devices through the network 1301. The network 1301 is a computer network, such as an enterprise intranet and/or the Internet. The network 1301 can include a LAN, a Wide Area Network (WAN), the Internet, wireless transmission mediums, wired transmission mediums, other networks, and combinations thereof. The computing system 1300 may connect to the network 1301 through a network interface unit 1304 connected to the system bus 1322. It should be appreciated that the network interface unit 1304 may also be utilized to connect to other types of networks and remote computing systems. The computing system 1300 also includes an input/output controller 1306 for receiving and processing input from a number of other devices, including a touch user interface display screen, or another type of input device. Similarly, the input/output controller 1306 may provide output to a touch user interface display screen or other type of output device.

As mentioned briefly above, the mass storage device 1314 and the RAM 1310 of the computing system 1300 can store software instructions and data. The software instructions include an operating system 1318 suitable for controlling the operation of the computing system 1300. The mass storage device 1314 and/or the RAM 1310 also store software instructions, that when executed by the one or more processors 1302, cause one or more of the systems, devices, or components described herein to provide functionality described herein. For example, the mass storage device 1314 and/or the RAM 1310 can store software instructions that, when executed by the one or more processors 1302, cause the computing system 1300 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein. Additionally, certain operations and method of the present disclosure are described as being performed by a particular component or group of components. However, such operations and methods are not limited to be performed by the described component or group of components. Depending on the embodiment, such operations may be performed by other components described herein. Moreover, functions and capabilities of components described herein may overlap or be associated with different components than described herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A dataset generation system comprising:
a computing system including one or more computing devices having a processor and a memory, the memory storing computer-implemented instructions executable on the processor to cause the computing system to generate a dataset having a plurality of samples, each sample of the plurality of samples including a respective initial query, a respective reference item, a respective follow-up query, and a respective target item, wherein generating the dataset comprises:
obtaining a plurality of initial queries;
for each initial query of the plurality of initial queries:
determining a reference item;
determining a target item, wherein the target item includes a modification relative to the reference item; and
generating a follow-up query, wherein generating the follow-up query comprises:
providing the initial query and a first prompt to a large language model (LLM) to determine an attribute type associated with the initial query;
providing the attribute type, reference item data, target item data, and a second prompt to a model to determine a reference item attribute value for the attribute type and a target item attribute value for the attribute type; and
providing a third prompt to the LLM to generate the follow-up query based on a difference between the reference item attribute value and the target item attribute value.

2. The dataset generation system of claim 1,
wherein generating the follow-up query further comprises prompting the LLM to create a non-binary question corresponding to the attribute type; and
wherein providing the attribute type, the reference item data, the target item data, and the second prompt to the model to determine the reference item attribute value for the attribute type and the target item attribute value for the attribute type comprises prompting a vision language model (VLM) to answer the non-binary question for a reference item image and a target item image.

3. The dataset generation system of claim 1,
wherein generating the follow-up query further comprises prompting the LLM to create a non-binary question corresponding to the attribute type; and
wherein providing the attribute type, the reference item data, the target item data, and the second prompt to the model to determine the reference item attribute value for the attribute type and the target item attribute value for the attribute type comprises prompting the LLM to answer the non-binary question for each of the reference item and the target item.

4. The dataset generation system of claim 1,
wherein the attribute type includes a plurality of attribute types;
wherein the reference item attribute value for the attribute type includes a plurality of reference item attribute values for the plurality of attribute types;
wherein the target item attribute value for the attribute type includes a plurality of target item attribute values for the plurality of attribute types;
wherein the difference between the reference item attribute value and the target item attribute value is a plurality of differences between the plurality of reference item attribute values and the plurality of target item attribute values; and
wherein generating the follow-up query further comprises:
prompting the LLM to rank the plurality of differences between the plurality of reference item attribute values and the plurality of target item attribute values; and
prompting the LLM to generate the follow-up query using ranked differences between the plurality of reference item attribute values and the plurality of target item attribute values.

5. The dataset generation system of claim 4, wherein generating the follow-up query further comprises filtering out attribute types in which corresponding attribute values for the reference item and target item are within a threshold of similarity to each other.

6. The dataset generation system of claim 1,
wherein determining the reference item comprises:
generating embeddings for the initial query;
comparing the embeddings for the initial query to a plurality of pre-computed embeddings for a plurality of items;
from the plurality of pre-computed embeddings, identifying reference item embeddings for the reference item as similar to the embeddings for the initial query; and
selecting the reference item;
wherein determining the target item comprises:
identifying a plurality of nearest neighbors to the reference item; and
selecting the target item from the plurality of nearest neighbors to the reference item.

7. The dataset generation system of claim 1, wherein the first prompt instructs the LLM to determine significant attribute types for a user that submits the initial query.

8. The dataset generation system of claim 1, wherein the computer-implemented instructions, when executed by the processor, further cause the computing system to:
evaluate the dataset using a multi-modal model to generate a validated dataset, wherein evaluating the dataset using the multi-modal model comprises, for each sample of the plurality of samples:
inputting the respective initial query, the respective reference item, and the respective follow-up query into the multi-modal model;
inferring, using the multi-modal model, the target item; and
comparing the inferred target item to the respective target item of the sample;
provide the validated dataset to a model training engine to train the multi-modal model.

9. The dataset generation system of claim 8, wherein inferring, using the multi-modal model, the target item comprises:
determining target item embeddings using the respective initial query, respective reference item, and respective follow-up query; and
selecting the target item using the target item embeddings.

10. The dataset generation system of claim 9, wherein determining the target item embeddings using the initial query, reference item, and follow-up query comprises:
providing the follow up query to the LLM to obtain an attribute type of the follow-up query and a preference associated with the attribute type;
prompting the LLM to detect a target phrase included in metadata associated with the reference item corresponding to the attribute type;
prompting the LLM to update metadata associated with the target item based on the target phrase, the attribute type of the follow-up query, and the preference associated with the attribute type; and
generating, using the multi-modal model, multi-modal embeddings for the target item using the updated metadata associated with the target item and using an image of the reference item.

11. The dataset generation system of claim 1,
wherein the reference item satisfies a first attribute specified in the initial query and does not satisfy a second attribute specified in the follow-up query; and
wherein the target item satisfies the first attribute specified in the initial query and the second attribute specified in the follow-up query.

12. The dataset generation system of claim 1,
wherein the plurality of initial queries include a plurality of top historical queries submitted to an online retailer;
wherein the reference item belongs to an item catalog of the online retailer; and
wherein the target item belongs to the item catalog of the online retailer.

13. A model development platform comprising:
a dataset generation system configured to generate a training dataset comprising a plurality of samples, wherein generating the training dataset comprises:
accessing a plurality of initial queries; and
for each initial query of the plurality of initial queries:
determining a reference item corresponding to the initial query;
determining a target item using data associated with the reference item; and
generating a follow-up query using one or more of a large language model (LLM) or a vision language model (VLM) to identify a difference between the reference item and the target item;
a dataset evaluation system configured to validate the training dataset using a multi-modal model to generate a validated training dataset, the validated training dataset comprising a subset of samples of the plurality of samples of the training dataset, wherein validating the training dataset comprises:
for each sample of the plurality of samples:
inputting an initial query of the sample, a reference item of the sample, and a follow-up query of the sample into the multi-modal model;
using the multi-modal model to infer a target item; and
comparing the inferred target item with the target item of the sample;
a model training system configured to train the multi-modal model using the validated training dataset.

14. The model development platform of claim 13,
wherein validating the training dataset generates a dataset of invalid samples;
wherein the dataset generation system is further configured to update one or more of a reference item, target item, or follow-up query of samples in the dataset of invalid samples; and
wherein the dataset evaluation system is further configured to, after the model training system trains the multi-modal model using the validated training dataset, validate the updated dataset of invalid samples using the trained multi-modal model.

15. The model development platform of claim 13,
wherein the dataset generation system is configured to generate a subsequent training dataset;
wherein the dataset evaluation system is configured to, after the model training system trains the multi-modal model using the validated training dataset, validate the subsequent training set using the trained multi-modal model to generate a second validated training set; and
wherein the model training system is configured to further train the trained multi-modal model using the second validated training set.

16. The model development platform of claim 13, wherein generating the follow-up query using one or more of the LLM or the VLM to identify the difference between the reference item and the target item comprises applying a query generation agent to iteratively query the one or more of the LLM or the VLM to identify differences between the reference item and the target item, prioritize the differences between the reference item and the target item, and generate the follow-up query using the prioritized differences.

17. The model development system of claim 13, wherein the trained multi-modal model is deployed as part of a chatbot.

18. The model development system 17, wherein the chatbot is configured to:
receive an initial query from a user;
in response to receiving the initial query, determine a reference item;
output the reference item to the user;
receive, from the user, a follow-up query that refers to the reference item and that indicates a modification to the reference item;
generate multi-modal target item embeddings using the trained multi-modal model by inputting the initial query, reference item data, and the follow-up query into the trained multi-modal model;
determine, using the multi-modal target item embeddings, a target item; and
output the target item to the user.

19. A method for generating a training dataset for a multi-modal machine learning model, the method comprising:
by one or more processors executing computer-readable instructions:
obtaining a plurality of initial queries;
for each initial query of the plurality of initial queries:
determining a reference item;
determining a target item, wherein the target item includes a modification relative to the reference item; and
generating a follow-up query, wherein generating the follow-up query comprises:
providing the initial query and a first prompt to a large language model (LLM) to determine an attribute type associated with the initial query;
providing the attribute type, reference item data, target item data, and a second prompt to a model to determine a reference item attribute value for the attribute type and a target item attribute value for the attribute type; and
providing a third prompt to the LLM to generate the follow-up query based on a difference between the reference item attribute value and the target item attribute value;
validating the training dataset using the multi-modal machine learning model; and
training the multi-modal machine learning model using the validated training dataset.

20. The method of claim 19, further comprising, by the one or more processors, generating multi-modal target item embeddings using the trained multi-modal machine learning model as part of generating a chatbot response to a user query.
